(19) United States
(12) Patent Application Publication
(10) Pub. No.: US 2004/0219504 A1
(43) Pub. Date: Nov. 4, 2004

(54) System, method and computer program for student assessment

(75) Inventor: John Hattie, Auckland (NZ)

Correspondence Address: NIXON & VANDERHYE, PC, 1100 N GLEBE ROAD, 8TH FLOOR, ARLINGTON, VA, 22201-4714, US

(73) Assignee: Auckland Uniservices Limited, Auckland (NZ)

(21) Appl. No.: 10/428,307

(22) Filed: May 2, 2003

(51) Int. Cl. G09B 7/00

(52) U.S. Cl. 434/353

(57) ABSTRACT

The invention provides a method of student assessment comprising the steps of analysing a curriculum into one or more curriculum functions; for one or more students storing a student profile in computer memory; storing in computer memory one or more test items for the curriculum comprising a test question and at least one curriculum function indicator, wherein each test question is calibrated to assess performance in at least one curriculum function of the curriculum and the curriculum function indicator represents the at least one curriculum functions assessed by the test question; obtaining from a user a test specification comprising one or more curriculum function indicators; generating a test comprising one or more question items selected and retrieved from data memory in accordance with the test specification; administering the test to one or more of the students; for each student that took the test determining one or more scores for each question item in the test; storing each score in the relevant student profile together with a reference to the corresponding question item; and generating a report for one or more of the students that took the test indicating performance levels for one or more of the curriculum functions tested. The invention also provides a related system and computer program.

### FIELD OF INVENTION

The invention relates to computer-implemented student assessment methods and in particular to a system, method and computer program for student assessment.

### BACKGROUND TO INVENTION

Often when students first enter school they are initially assessed by means of a standardised test intended to give the school or teacher some idea as to the student's understanding and competence in such areas as numeracy, oral language, and emergent literacy.

During the course of schooling, it is common for further standardised tests to be administered intermittently to check on the student's progress in such basic areas as reading comprehension, reading vocabulary, mathematics and listening comprehension The standardised tests currently available or in use in schools are deficient in several ways.

Standardised tests are usually aimed at obtaining an overall “score” for a particular skill such as reading comprehension, writing, or mathematics for example. Such a general score does not recognise that a broad skill such as reading comprehension, for example, requires a student to exercise several specific sub-skills or cognitive functions. In many cases, two children may attain the same “score” on these tests but for different reasons. In other words, the two children may have different strengths and weaknesses amongst the cognitive functions making up the overall skill or subject tested but this will not be identified by the test results. Often it is difficult for schools and teachers in particular, to obtain any useful information about the particular strengths and weaknesses of a particular student or indeed their class groups as a whole from the standardised tests currently in use. They do not allow teachers to trace the progress of their students in any detailed or meaningful way or identify particular areas of difficulty for their own students in order to target those areas in the future.

Furthermore, the results of such tests are interpreted by comparing them to a national “average” and do not allow teachers to compare the progress of their students directly to other groups of students in similar schools or with similar backgrounds.

In addition, present standardised tests are often the same for whole counties. They are not targeted to the specific circumstances of a particular region, school, or class group. In some cases, the tests may even be imported from overseas and therefore are not even well related to the local curriculum.

It would be desirable to provide a method of student assessment which is both standardised and which may be directed to relevant local curriculum and circumstances.

It would also be desirable to have a method of student assessment that is customisable according to teaching requirements and/or a particular school environment.

It would also be desirable to provide a means of interpreting and reporting the results of standardised assessment in a way that is meaningful to teachers, parents and students in terms of local environment, circumstances, student background and/or the school or other student relevant variables.

### SUMMARY OF INVENTION

In broad terms in one form the system provides a method of student assessment comprising the steps of: analysing a curriculum into one or more curriculum functions; for one or more students storing a student profile in computer memory; storing in computer memory one or more test items for the curriculum comprising a test question and at least one curriculum function indicator, wherein each test question is calibrated to assess performance in at least one curriculum function of the curriculum and the curriculum function indicator represents the at least one curriculum functions assessed by the test question, obtaining from a user a test specification comprising one or more curriculum function indicators; generating a test comprising one or more question items selected and retrieved from data memory in accordance with the test specification; administering the test to one or more candidate students; for each student that took the test determining one or more scores for each question item in the test; storing each score in the relevant student profile together with a reference to the corresponding question item; and generating a report for one or more of the candidate students indicating performance levels for one or more of the curriculum functions tested.

In broad terms in another form the invention provides a student assessment system comprising a student profile for one or more students; a test item bank comprising a plurality of test items, each test item comprising a test question and at least one curriculum function indicator wherein the question item is calibrated to the at least one curriculum function indicated by the at least one curriculum function indicator; a test generator configured to: a) receive test specification data comprising one or more curriculum function indicators, b) select and retrieve one or more test items from computer memory according to the test specification, and c) assemble the selected test item(s) into a test, and a report generator configured to: a) receive result data comprising a score for each student that took the test generated by the test generator for each test item in the test and store the result data in a corresponding student profile; and b) generate a report for one or more of the students that took the test generated by the test generator indicating performance levels for one or more of the curriculum functions tested by the test items.

In broad terms in yet another form the invention provides a student assessment computer program comprising a student profile maintained in computer memory for one or more students; one or more test items for the curriculum maintained in a computer memory comprising a test question and at least one curriculum function indicator, wherein each test question is calibrated to assess performance in at least one curriculum function of the curriculum and the curriculum function indicator represents the at least one curriculum functions assessed by the test question; a test generator configured to a) receive test specification data comprising one or more curriculum function indicators; b) select and retrieve one or more test items from computer memory according to the test specification, and c) assemble the selected test item(s) into a test, and a report generator configured to a) receive result data comprising a score for each student that took the test generated by the test generator for each test item in the test and store the result data in a corresponding student profile; and b) generate a report for one or more of the students that took the test generated by the test generator indicating performance levels for one or more of the curriculum functions tested by the test items.

### BRIEF DESCRIPTION OF THE FIGURES

Preferred forms of the method system and computer program for student assessment will now be described with reference to the accompanying figures in which:

FIG. 1 shows a block diagram of a system in which one form of the invention may be implemented;

FIG. 2 shows the preferred system architecture of hardware on which the present invention may be implemented;

FIG. 3 shows some of the data which may be stored to implement the invention;

FIG. 4 shows a flow diagram of the basic steps in the methodology of the invention;

FIG. 5 shows a possible division of a curriculum into curriculum levels,

FIG. 6 shows a further subdivision of a curriculum into curriculum levels set out in table format;

FIG. 7 shows an item characteristic curve from Item Response Theory;

FIG. 8 shows an item information curve from Item Response Theory;

FIG. 9 is a diagram illustrating an example curriculum map for a Reading curriculum;

FIG. 10 is a diagram illustrating an example curriculum map for a Mathematics curriculum;

FIG. 11 is a diagram illustrating an example curriculum map for a Writing curriculum;

FIG. 12 shows a sub-division of the Reading curriculum into sub-functions;

FIG. 13 shows one basic form of a preferred user interface for the main menu of the invention;

FIG. 14 shows one basic form of a preferred user interface for entering or maintaining school data;

FIG. 15 shows one basic form of a preferred user interface for entering or maintaining class data,

FIG. 16 shows one basic form of a preferred user interface for entering or maintaining student data,

FIG. 17 shows one basic form of a preferred user interface for entering test specification data;

FIG. 18 shows one basic form of a preferred user interface for entering test specification data;

FIG. 19 shows one basic form of a preferred user interface for entering test specification data;

FIG. 20 shows one basic form of a preferred user interface for entering test specification data;

FIG. 21 shows one basic form of a preferred user interface for entering test specification data;

FIG. 22 shows a flow diagram of one preferred method of generating a test;

FIG. 23 shows a flow diagram of one preferred method of selecting testlets and test items for inclusion in a test;

FIG. 24 shows one form of a preferred user interface for managing tests,

FIG. 25 shows a portion of a preferred form of a test generated according to the invention;

FIG. 26 shows a portion of a preferred form of a test generated according to the invention;

FIG. 27 shows a portion of a preferred form of a test generated according to the invention;

FIG. 28 shows a portion of a preferred form of a test generated according to the invention;

FIG. 29 shows a portion of a preferred form of a test generated according to the invention,

FIG. 30 shows a portion of a preferred form of a test generated according to the invention;

FIG. 31 shows a portion of a possible scoring guide for a Writing test generated according to the invention;

FIG. 32 shows a portion of a possible scoring guide for a Writing test generated according to the invention;

FIG. 33 shows a portion of a possible scoring guide for a Writing test generated according to the invention;

FIG. 34 shows a portion of a possible scoring guide for a Writing test generated according to the invention;

FIG. 35 shows one basic form of a preferred user interface for entering student scores;

FIG. 36 shows one basic form of a preferred user interface for entering student scores;

FIG. 37 shows one basic form of a preferred user interface for generating reports in accordance with the invention;

FIG. 38 shows one basic preferred form of a report generated by the invention;

FIG. 39 shows one basic form of a preferred user interface for targeting comparisons in a report generated by the invention;

FIG. 40 shows one basic preferred form of a report generated by the invention;

FIG. 41 shows one basic preferred form of a report generated by the invention;

FIG. 42 shows one basic preferred form of a report generated by the invention.

### DETAILED DESCRIPTION OF PREFERRED FORMS

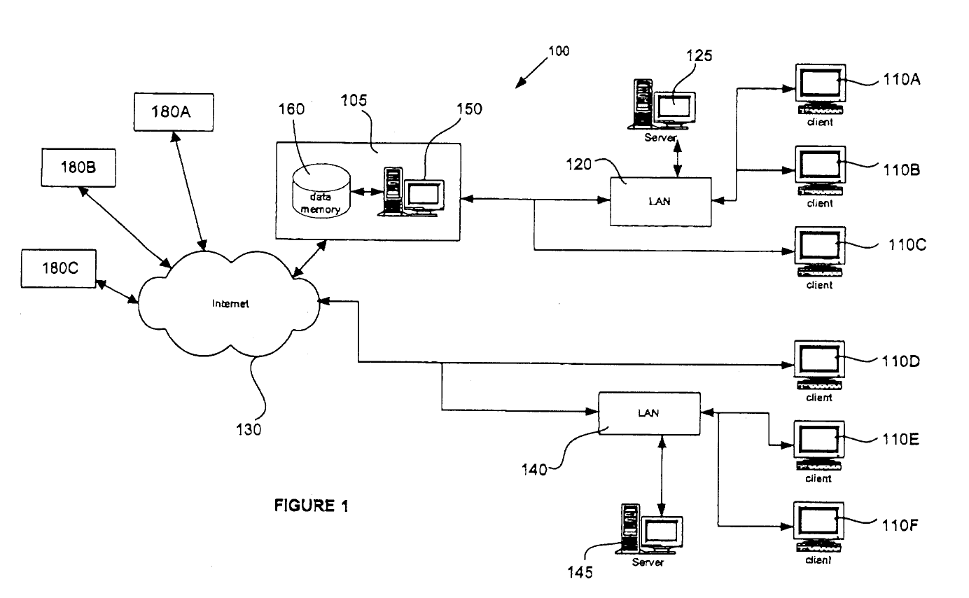

FIG. 1 illustrates a block diagram of a preferred system 100 in which one form of the present invention may be implemented.

In its most preferred form the invention is implemented on a personal computer or workstation operating under the control of appropriate operating and application software having a data memory 160 connected to a server or workstation 150. The combination of these preferred elements is indicated at 105.

Data memory 160 may store all local data for the method system and computer program of the invention.

An alternative is that the system 100 include one or more clients 110, for example 110A, 110B, 110C, 110D, 110E and 110F, which each may comprise a personal computer or workstation described below. Each client 110 is interfaced to 105 as shown in FIG. 1. Each client could be connected directly to the invention at 105, could be connected through a local area network or LAN, or could be connected through the Internet.

Clients 110A and 110B for example are connected to the network 120, such as a local area network or LAN. The network 120 could be connected to a suitable network server 125 and communicate with the invention as shown. Client 110C is shown connected directly to the invention 105. Clients 110D, 110E and 110F are shown connected to the Internet 130. Client 110D is shown as connected to the Internet 130 with the dial-up connection and clients 110E and 110F are shown connected to a network 140 such as a local area network or LAN with the network 140 connected to suitable network server 145.

It will be appreciated that a client 110 may be connected to the invention at 105 directly, via a network or via the Internet 130 by any available means such as, for example, wireless or cable. In this preferred form, the data and software for performing the invention may be distributed across clients 110 and the invention 105.

In either embodiment, the invention may also access remote resources 180 via the Internet 130 which may then be used in conjunction with the invention.

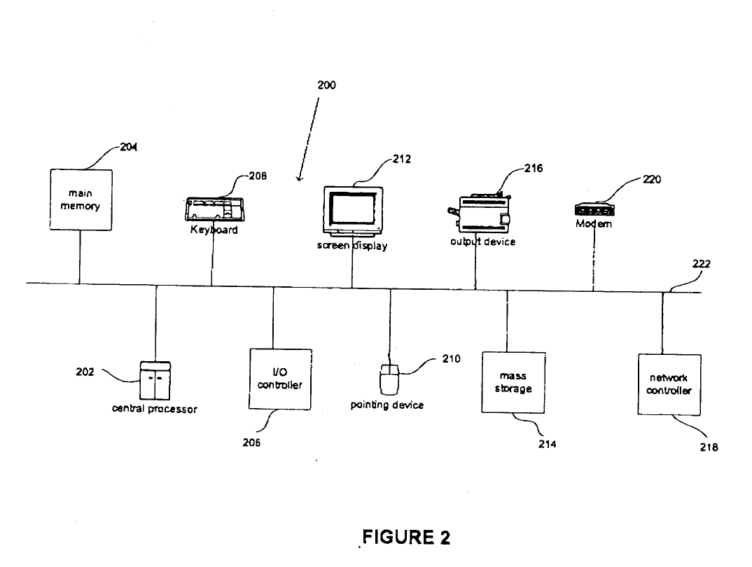

FIG. 2 shows the preferred system architecture of a personal computer, workstation, or server such as 110 or 150. The computer system 200 typically comprises a central processor 202, a main memory 204, for example RAM, and an input/output controller 206. The computer system 200 may also comprise peripherals such as a keyboard 208, a pointing device 210, for example a mouse, touchpad, or trackball, a display or screen device 212, a mass storage memory 214, for example a hard disk, floppy disk or optical disc and an output device 216 such as a printer. The system 200 could also include a network interface card or controller 218 and/or a modem 220. The individual components of the system 200 could communicate through a system bus 222.

The invention is primarily embodied in the methodology set out below both by itself and as implemented through computing resources as the preferred resources set out in FIGS. 1 and 2, by way of example. The invention is also embodied in the software used to implement the methodology and in any system comprising a combination of hardware and software used to implement the methodology.

The invention may be used or applied in conjunction with any curriculum but is described in this specification, by way of example only, in relation to Reading, Writing, and Mathematics curricula in particular.

In its most basic embodiment the invention allows a user to create tests for customisable standardised assessment, manage and administer such tests, and manage and review student data, particularly data related to the results attained by students when they take the tests generated by the invention.

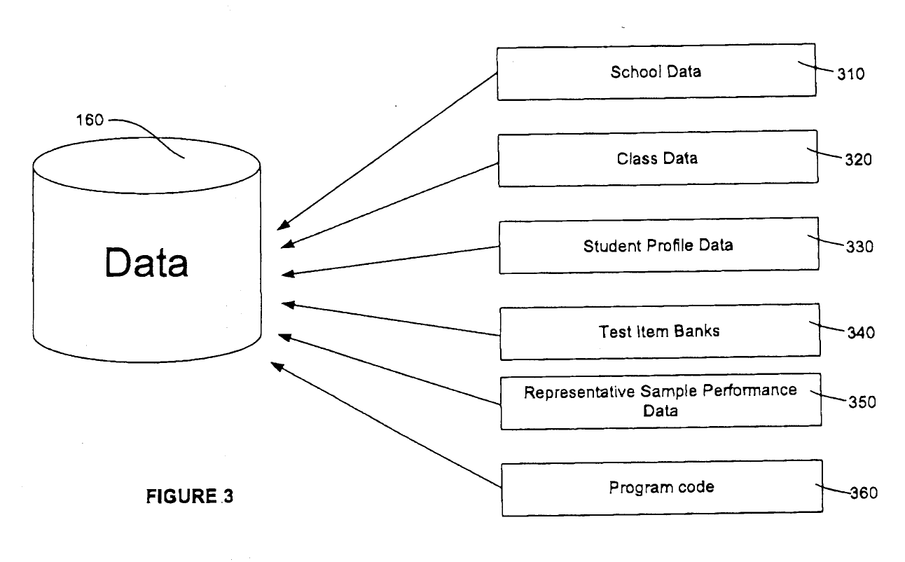

FIG. 3 illustrates some of the data that may be stored in system 100 at 160 or any other appropriate place on the system in order to carry out the functions mentioned above. The invention will typically use data relating to individual students 330 including basic information such as name, age and so on. Student data may in turn be related to class data 320 representing information about the class groups in which they study. Student data may also be related to school data 310 representing information about the school the student attends. Data about students may be referred to as a student profile and may incorporate by reference relevant class data and school data. School, class and student data may be stored in a relational database or in any other appropriate form.

The invention will also require one or more test item banks 340 comprising test items that may be incorporated into a test. The invention may also make use of Representative Sample Performance Data 350 to provide externally referenced comparative performance data for the generation of reports.

The invention will also rely on program code comprising implementation methods for carrying out the methodology of the invention.

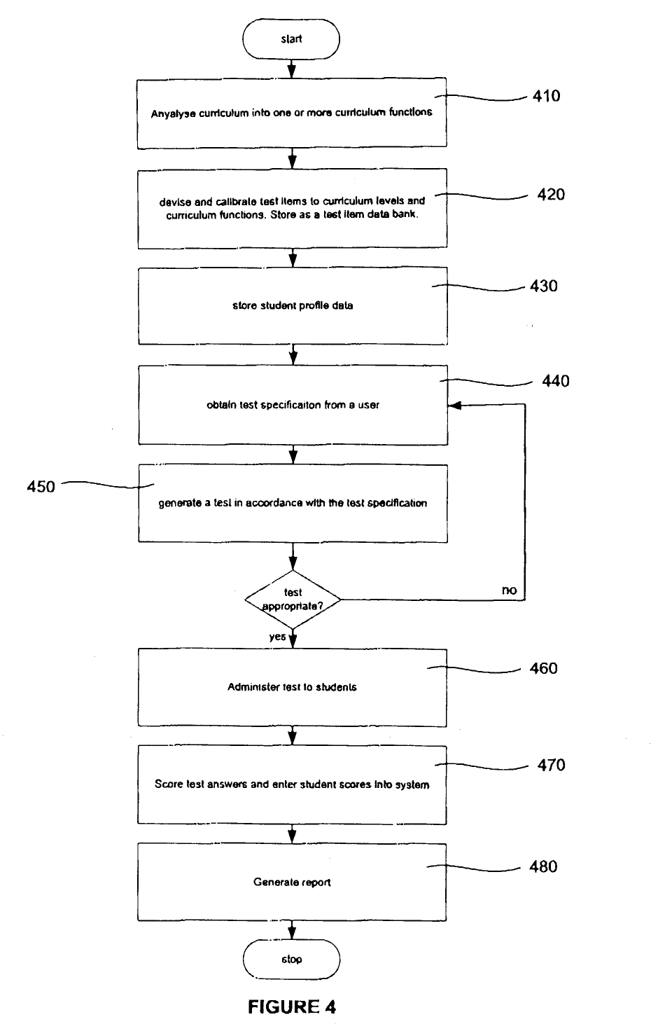

FIG. 4 is a flow diagram of the basic steps in implementing the methodology of the invention.

As shown in FIG. 3 the invention needs at least one bank of test items 340 stored in system 100 or accessible via system 100. Each bank of test items will be targeted to a particular subject or learning objective to be assessed. For example there may be a Reading item bank, a Writing item bank, and a Mathematics item bank.

For an appropriate bank of test items to be devised the curricula of interest must first be analysed into curriculum functions and preferably curriculum levels as described below and shown at 410 in FIG. 4. Then test items must be devised and calibrated onto the curriculum functions and preferably the curriculum levels that have been identified as shown at 420 in FIG. 4.

Individual test items are likely to comprise a test question, a scoring guide, reference to the level of difficulty of the question (a curriculum level indicator), reference to the curriculum function assessed by the question (a curriculum function indicator), and reference to any additional materials that are necessary to complete the question item such as a text in the case of a reading question item for example. A group of related test items may be referred to as a testlet and is described in more detail further below.

The items of each item bank may be associated with one or more curriculum levels as described below.

It is common for national education authorities to provide guidelines, especially in such fundamental curricula as reading, writing, and mathematics, as to the levels of achievement expected from students as they progress through their schooling. These levels will usually be related in some way to the year or grade a student has reached in their schooling.

The grade or year of study of a student may be referred to using different classifications and nomenclature depending on the education system of the country in which the invention is used. Throughout the specification it will be assumed that the average student completes 13 years of schooling between the time they enter the school system at the age of 5 or 6 and the time they graduate high school. Grades of study will be referred to generically as Years 1 to 13 throughout the specification.

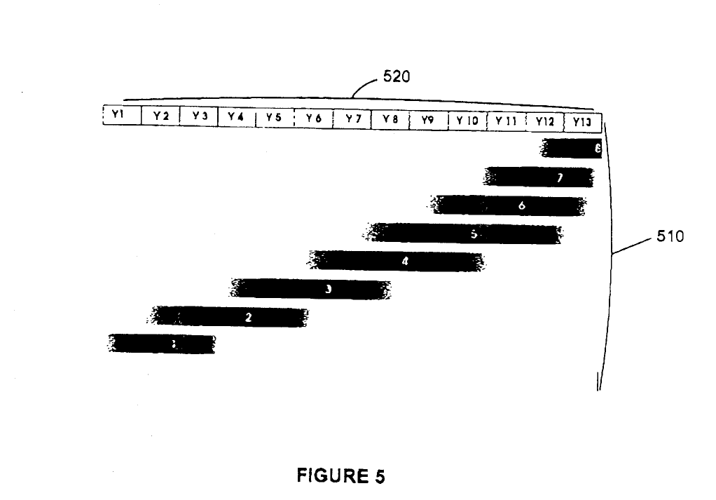

FIG. 5 is a diagram showing the levels of achievement or progress 510 expected from students in fundamental curricula at each grade 520 as specified by the New Zealand Ministry of Education Curriculum Framework. Particular learning benchmarks defining student progress and development within a curriculum will usually be specified for each curriculum level in the relevant curriculum statements issued by local state educational authorities.

Such state-provided guidelines which divide curricula into curriculum levels are a useful starting point in designing an assessment tool to track student progress and development and such guidelines should be referred to when implementing the methodology of the invention whenever possible. However the levels set out in such guidelines may be too broad to track student progress in any detail, as is the case with the curriculum levels shown in FIG. 5.

Under the guidelines in FIG. 5, students are expected to take two years to progress through one level of the curriculum which provides an extremely broad measure of student progress. For the purposes of the invention it is preferred that overly broad curriculum level definitions be further sub-divided. The analysis necessary for this work should be done by qualified professionals with some experience of the curriculum levels defined for any particular country in which the invention is to be used.

It is further preferred that for the purposes of the invention any overlap between curriculum levels should be eliminated wherever possible. In this way the curriculum levels defined will form a single achievement proficiency continuum.

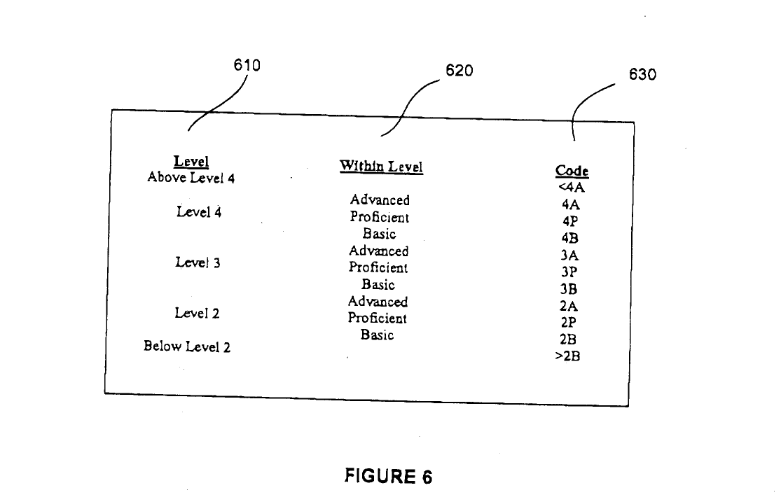

By way of example, the curriculum levels illustrated in Fig. 5 may be subdivided as shown in FIG. 6. FIG. 6 illustrates in particular the subdivision of levels two to four of the New Zealand curriculum levels. The specification will have reference throughout to levels 2 to 4 of the New Zealand curriculum by way of example only. Any obvious adaptation of the methodology to other grades and curriculum levels of any curricula are encompassed by the invention.

Where the sub-division of curriculum levels is necessary, such subdivisions should preferably be referred to by names that indicate progression. In this case each level has been divided into three sub-levels. The sub-level that defines early stages of development within a curriculum level is referred to as Basic, the sub-level that defines middle stages of development within a curriculum level is referred to as Proficient, and the sub-level that refers to late stages of development within a curriculum level is referred to as Advanced as indicated in column 620 of the table in FIG. 6.

The curriculum levels so divided may be referred to by the short-hand codes shown in column 630. For example level three basic may be referred to as 3B, level three proficient may be referred to as 3P, and level three advanced may be referred to as 3A.

Test items categorised into a particular curriculum level may be sub-categorised as basic if they require partial mastery of knowledge and skills that are fundamental to performing tasks at the level in which the test item is categorised.

Test items categorised into a particular curriculum level may be sub-categorised as Proficient if they are items that are simple applications of the knowledge and skills that are fundamental to performing tasks at the level in which the test item is categorised. Test items categorised into a particular curriculum level may be sub-categorised as Advanced if they are difficult applications of the knowledge and skills fundamental to performing tasks at the level in which the test item is categorised.

Locally accepted curriculum levels may be sub-divided into more or fewer sub-levels as is most advantageous for implementing the methodology of the invention.

Question items devised for use with the invention and then stored in each item bank are preferably calibrated onto the achievement proficiency continuum provided by the curriculum levels and sub-levels, using Item Response Theory models.

Item Response Theory is the study of test and item scores based on assumptions concerning the mathematical relationship between student abilities and student responses to question items.

In Item Response Theory student ability (θ) is measured in logits (log-odds units). At each ability level, there will be a certain probability that a student with that ability will give a correct answer to the item. One logit is the increase in the ability variable that increases the odds of the examinee giving a correct answer by a factor of 2.718 (or “e”) the base of natural logarithms. All logits are the same length with respect to this change in the odds of a correct answer.

P(θ) is the Item Characteristic Function and defines the probability that a student will give a correct response to a question item as a function of the students ability in logits (θ)

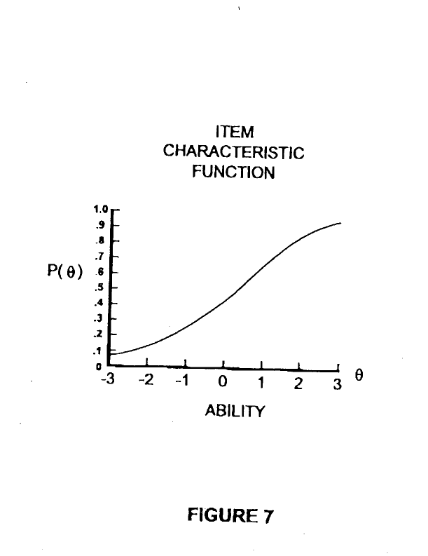

FIG. 7 shows a typical Item Characteristic Curve. Each item in a test will have its own Item Characteristic Curve.

There are various models for this function. The preferred model for the present invention is formulated by the following equation:

$$P ( θ ) = \frac{exp ( θ - {b}_{i} )}{1 + exp ( θ - {b}_{i} )}$$

Where bᵢ denotes the difficulty of the question item i and θ is the ability variable as described above. The primary importance of the Item Characteristic Function in the present invention is in the derivation of a function that will define the information that can be derived from a particular item and ultimately a particular test made up of one or more items.

An important feature of IRT models is the concept that item information is the reciprocal of the standard error of measurement. Items with a low standard error will give greater information and vice versa. In other words, the reciprocal of the precision with which ability can be estimated from an item defines the amount of information about student abilities that can be derived from that item. If the amount of information for an item is large, then a student whose true ability is at the level of the item can be estimated with precision. If on the other hand the amount of information for an item is small, then ability cannot be estimated with precision from that item and responses to the item will be scattered about the true ability.

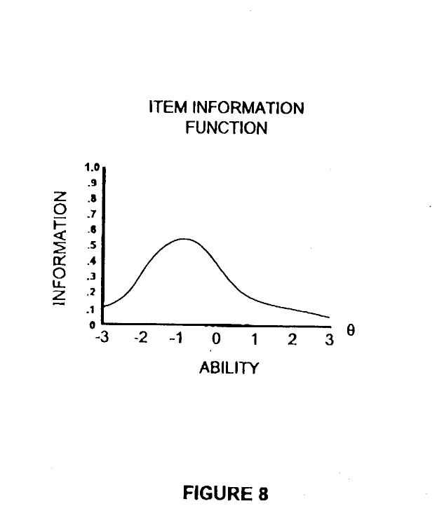

Using the appropriate formula, the amount of information can be computed for each ability level on the ability scale. An example curve that plots the amount of information against ability is shown in FIG. 8.

In the example curve shown in FIG. 8, the amount of information has a maximum at an ability level of −1.0 at about 5. At this maximum, ability is estimated with some precision, while outside the maximum the amount of information decreases rapidly. Clearly an item information curve with a sharp maximum at a very high value of I would be preferred for estimating ability from a particular item.

In Item Response Theory each item of a test should ideally measure a particular underlying trait or ability. As a result the amount of information I based upon a single item, can be computed at any ability level and is denoted by I,(θ), where i indexes the item.

An item measures ability with greatest precision at the ability level corresponding to the item's difficulty parameter.

The ability levels used in the exemplary embodiments of the invention as described in this specification focus the question items on twenty ability levels spread evenly slightly beyond the 2b-4a range described above, by way of example only.

For the preferred model for the invention an item information function can be estimated using the following equation:

Iᵢ(θ)=Pᵢ(θ)[1−Pᵢ(θ)]

For some curricula, such as writing for example, where assessment questions are by their nature open-ended, the same question item may be appropriate for a reasonably broad range of curriculum levels. In such cases the level of achievement attained by a student will have to be judged more specifically through the scoring process and the particular achievement levels must be clearly defined in a scoring guide for the question item.

Test items devised for use with the invention for each curriculum are also calibrated and categorised according to curriculum functions. Curriculum functions define particular knowledge, skills and/or cognitive functions that are fundamental to a curriculum. The process of identifying the fundamental skills, knowledge and cognitive functions that make up a curriculum may be referred to as “curriculum mapping” because, as the name suggests, the subject curriculum is mapped according to the “rich ideas” that underlie the curriculum. Each test item devised for use with the invention should be capable of testing performance in a single curriculum function and will therefore be associated with a curriculum function indicator that identifies the curriculum function tested by that item.

The particular curriculum map used for a curriculum to implement the present invention will be dependent on local factors such as the emphasis placed on different aspects of the curriculum by local educational authorities. In addition, curriculum maps may become more complex as students progress to the upper levels of the curriculum and more specialised skills are expected.

A curriculum map may focus on identifying the particular skills and mental processes used in a curriculum but it may also focus on distinctions between surface objectives and deeper meaning-making cognitive processes. In the context of a Writing curriculum for example, surface features may include, spelling and grammar, while deeper features may include narrating, explaining or persuading.

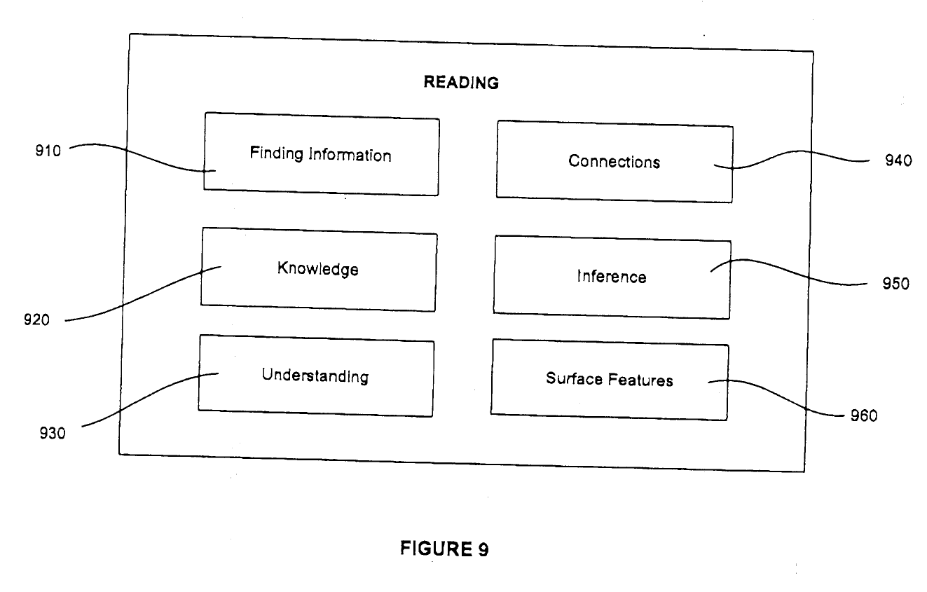

FIG. 9 shows one possible result of mapping the New Zealand Reading curriculum for curriculum levels two to four. The main curriculum functions identified are Finding Information 910, Knowledge 920, Understanding 930, Connections 940, Inference 950, and Surface Features 960.

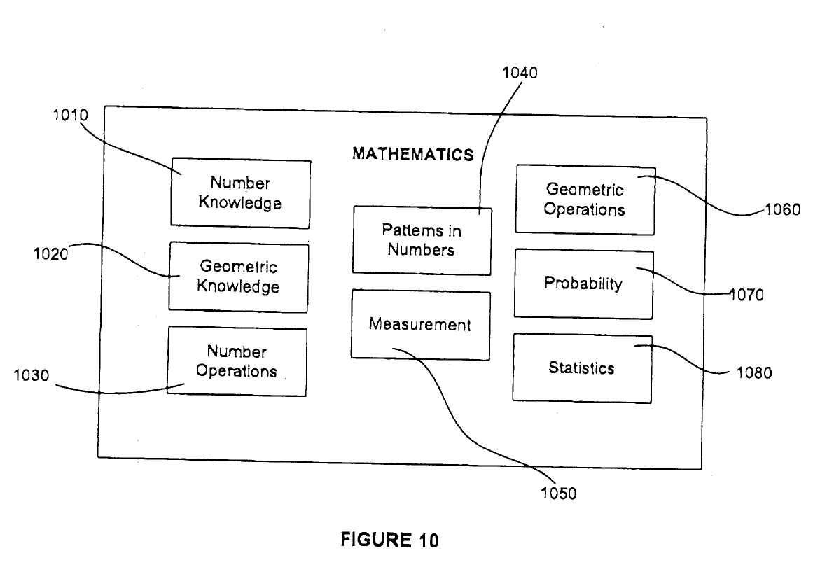

FIG. 10 shows one possible result of mapping the New Zealand Mathematics curriculum for levels two to four. The curriculum functions identified include Number Knowledge 1010, Geometric Knowledge 1020, Number Operations 1030, Patterns in Numbers 1040, Measurement 1050, Geometric Operations 1060, Probability 1070, and Statistics 1080.

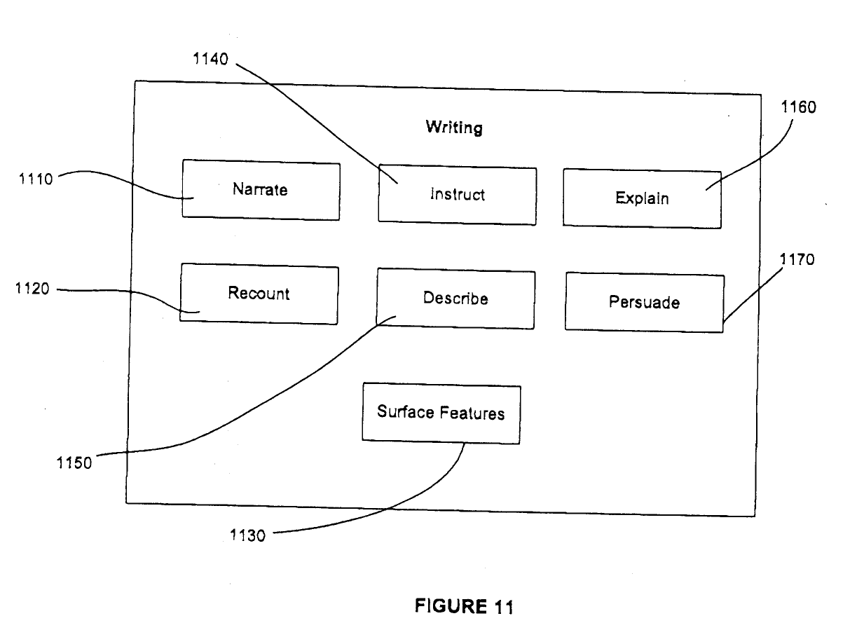

FIG. 11 shows one possible result of mapping the New Zealand Writing curriculum. The curriculum functions involved in the Writing curriculum have been analysed and defined primarily according to the purpose of any given text. Curriculum functions identified include Narrate 1110, Recount 1120, Surface Features 1130, Instruct 1140, Describe 1150, Explain 1160, and Persuade 1170.

Each curriculum function may be logically made up of a number of sub-functions or performance objectives within each curriculum function.

By way of example, the reading curriculum functions identified in FIG. 9 may be made up of the sub-functions set out below for curriculum levels 2 to 3.

Finding Information

Find, select & retrieve information

Skim/scan for information

Note take in a variety of ways

Use dictionary, thesaurus, and atlas

Identify fiction & non-fiction texts

Knowledge

Knowledge of vocabulary

Knowledge of poetic & figurative language

Knowledge of semantic, syntactic & visual grapho-phonic cues

Knowledge of strategies to solve unknown words & gain meaning

Knowledge of publishing conventions

Understanding

Consistently read for meaning

Understanding/identification of main ideas

Understanding of detail to support main ideas

Use understandings & information

Question to clarify meaning

Discuss texts & identify aspects

Connections

Compare similarities & differences within & between texts

Make links between aspects of text

Make use of prior knowledge

Understand & organise or sequence material

Empathise with characters & situations

Make links between verbal & visual information

Inference

Explore author's purpose & question intent

Make inferences

Read critically for: bias, stereotyping & propaganda

Predict possible outcomes

Identify and discuss purposes of text

Surface Features

Grammar

Identify word classes

Use grammatically correct structures

Identify features or characteristics of text

Punctuation

Spelling

By way of a further example, the mathematics curriculum functions identified in FIG. 10 may be made up of the sub-functions set out below for curriculum levels 2 to 4.

Number Knowledge

Read, explain, and order whole numbers

Explain negative numbers

Explain and evaluate powers

Explain meaning of digits & order numbers to 3 decimal places

Number Operations

Recall and user addition/subtraction/multiplication facts

Add, subtract, multiply, divide whole numbers

Use and solve simple linear equations

Use, sketch, and interpret graphs

Write and solve story and practical problems with whole numbers

Make and check sensible estimates

Use, find and express fractions or percentages or decimals of a whole

Write and solve story and practical problems with decimals, fractions

Find and convert equivalent fractions-decirnals-percentages

Patterns in Numbers/Pre-Algebra

Continue, describe, find, and make up rules for number and spatial patterns

Use rules to predict patterns

Solve simple linear equations

Knowledge of order of operation convention

Measurement

Describe, draw, specify and interpret position with direction, distance, scale maps, bearings or grid references

Measure and estimate units of length, mass, volume, area, temperature, capacity

Measure and read units and scales to nearest gradation

Read and convert digital and analogue clocks

Perform time calculation with 12 and 24 hour clocks

Know units of time

Read, interpret and construct time statements, scales, tables and charts

Geometric Knowledge

Name and describe features of 2D and 3D objects

Calculate perimeter, area, volume

Describe symmetries

Identify clockwise, anticlockwise, quarter, and half turns

Know about simple angles including 90° (right-angle) and 180°, 30°, 45°, and 60°

Geometric Operations

Create, describe, and design geometric patterns with translation, reflection, and rotation

Enlarge or reduce 2D objects

Make turns

Use protractor to measure angles

Make, model, construct, draw, name and describe 2D and 3D shapes

Design and make containers or nets for simple polyhedrons

Probability

Plan investigations and collect appropriate data

Predict events by likelihood

Compare, count, and diagram possible outcomes

Assign, predict probabilities and frequencies of events

Estimate frequencies and mark on scale

Statistics

Plan investigation and collect data

Collect, display data

Choose and construct data displays

Design and user simple scales

Discuss and report distinctive features of data displays

Make and evaluate statements about and interpretations of data

Such sub-functions will be naturally present in all curriculum functions that are broad enough to be used as a basis for focussed assessment. Sub-functions are even more specific to local curricula than curriculum functions and are therefore preferably analysed independently in each country of use. Curriculum sub-functions will also be highly dependent on the nature of the curriculum functions defined.

For example, sub-functions for each of the writing curriculum functions outlined above may be the same in some cases due to the nature of the writing curriculum functions and, in particular, the way the functions have been determined by the purpose of the text.

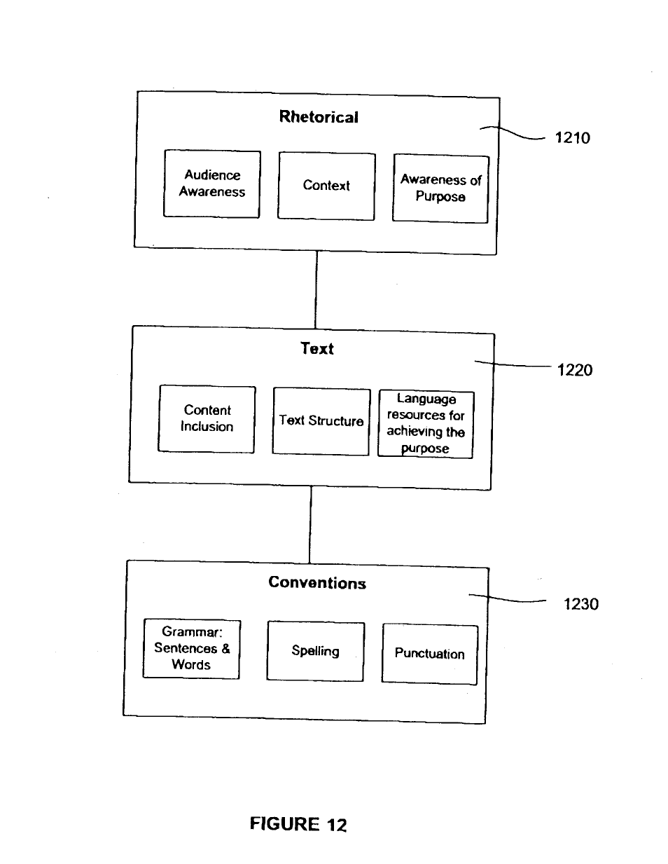

FIG. 12 is a diagram illustrating one preferred analysis of each Writing curriculum function described above into sub-functions. In this analysis, each curriculum function will contain sub-functions related to rhetorical features 1210, the text itself 1220, and conventions 1230 such as grammar, spelling, and punctuation. Rhetorical features may include awareness of context; purpose; and the audience. Sub-functions related to the text itself may include text structure; content inclusion; and language resources. Rhetorical and Text features will be different for each curriculum function, while features of Convention such as grammar, spelling, and punctuation will be identical for each function.

Data identifying the sub-function tested by a question item may also be associated with each question item in an item bank where appropriate.

For curricula requiring open-ended assessment questions such as writing for example, clear identification of the sub-functions being assessed in the scoring guide for the question item may be essential in order to obtain meaningful results from the assessment test.

In addition to the test item data the invention may require some data about the students who are candidates for the tests generated by the invention 330. The step of acquiring this data will typically be carried out at the school where the students study via software embodying the methodology of the invention and is shown at step 430 in FIG. 4.

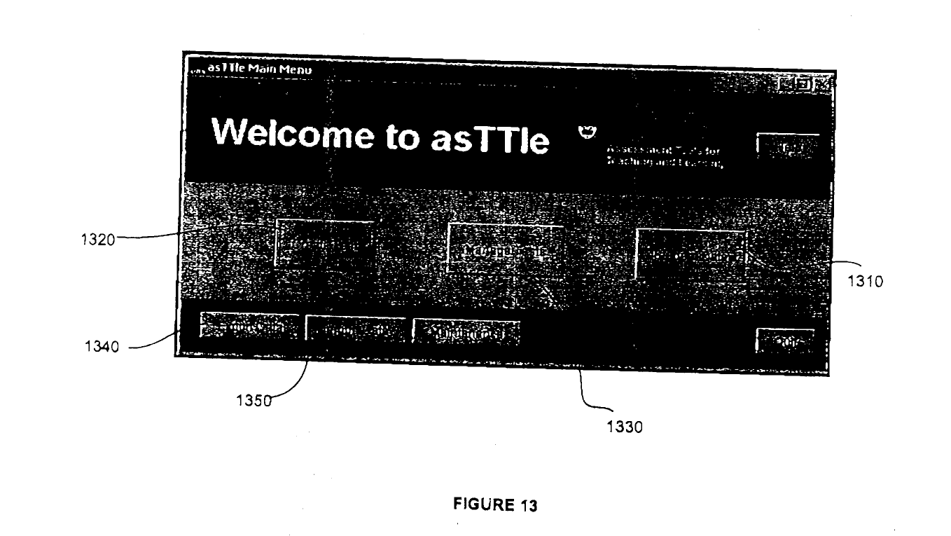

FIG. 13 shows, by way of example, a basic user interface that may be used to access the functionality of the invention. From the welcome screen shown in FIG. 13 the user may, for example, choose to access student data by clicking on or otherwise selecting the student data button 1310.

If the invention is being used for the first time by the particular user it may be necessary to enter school, class, and student details to set up the system for use. If this is the case the invention may automatically provide the user with an appropriate interface with prompts in order to do this.

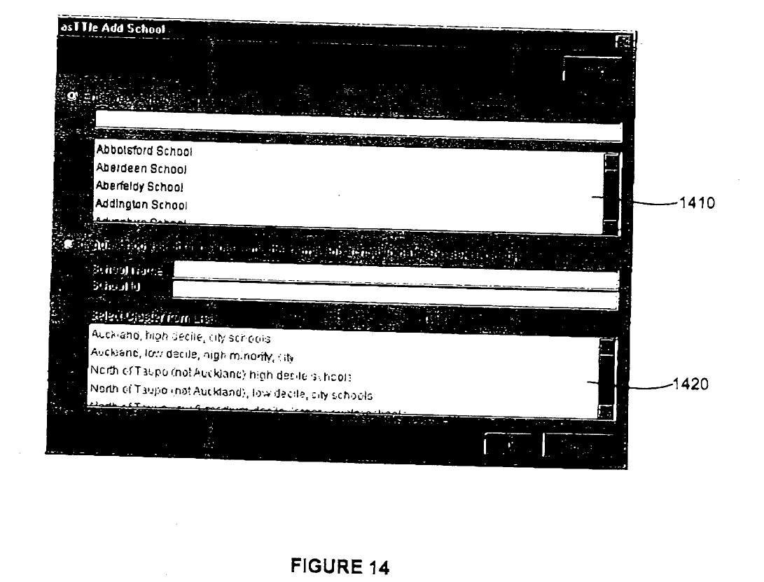

FIG. 14 shows an example of such an interface. In this example the user is prompted first for data about the school in which the invention is to be used. Information about the school is particularly useful for making full use of some of the reporting functions of the invention described later in the methodology. Data that may be useful in this respect includes such factors as the size of the school, the school decile rating, the proportion of minority students who attend the school, school type, for example public or private, the geographic location of the school, and location type for example, urban or rural.

In the context of this specification ‘decile rating’ refers to the most prevalent socioeconomic conditions of the students at a school as measured on a scale of one to ten.

Data for state schools about which authorities have detailed information and statistics, including the type of information mentioned above, may already be present in the system 100 if the information is freely available and may therefore be pre-entered. If the user is preparing assessments for students at a school that is already entered into the system, the user may simply select the appropriate school from a list 1410 as shown in FIG. 14.

If relevant information about the school is not on the system 100, the user may be asked to enter the name of the school and select a description or a series of attributes that best describes the school from one or more lists, for example, 1420.

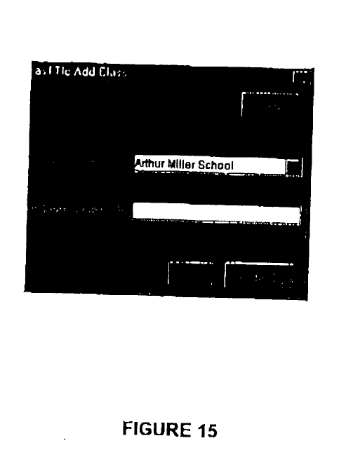

Once the school data has been entered as shown in FIG. 14, the user may be prompted for data relating to the class within the school whose members are to be assessed as shown in FIG. 15. This data may be limited to simply the name or designation of the class or may, particularly in the case of special purpose classes, also include information such as any special needs of the students of that class for example, that the students are not native speakers of the language of instruction at the school.

Once school and class data has been entered the user may enter student data for each school and class entered.

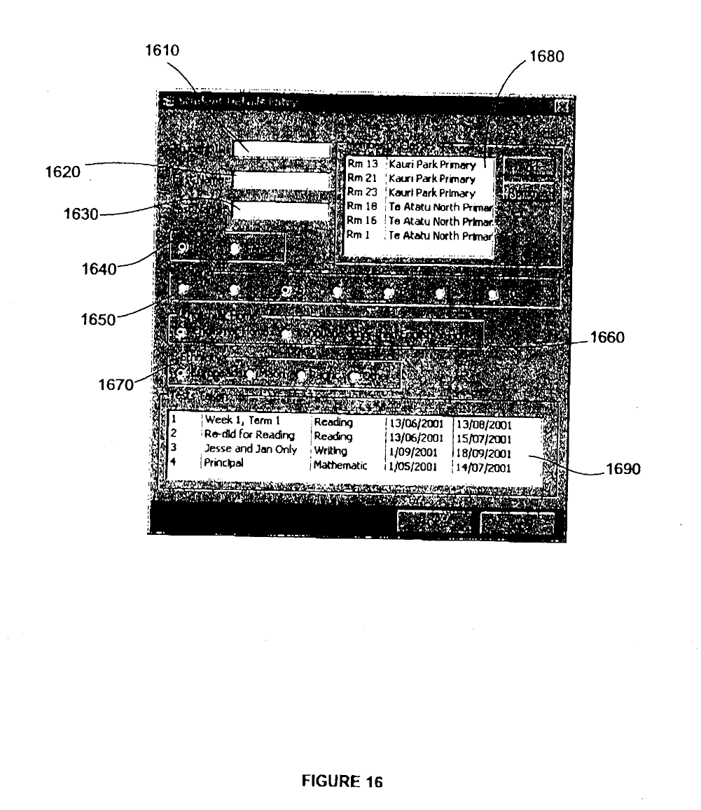

FIG. 16 shows one possible data interface configured to allow a user to enter important data about a student into the system 100. The information stored in the system about a student may be referred to as a student profile, as described above and will include reference to relevant school and class data.

Relevant information stored in the student profile will include such basics as the student's ID number (if applicable) 1610, first name 1620, last name 1630, and school Grade 1650. The student profile will preferably also include the student's gender 1640, ethnicity 1670, and whether the student speaks the language of instruction or another language at home 1660. In the example shown. English is the language of instruction at the school.

Other information accessible in the student profile may include class membership information as shown at 1680 and information regarding the assessment tests already administered to the student as shown at 1690. More detailed information about the scores obtained by the student in the assessments will also be stored in the student profile which may be accessible by selecting an assessment from list 1690.

It is envisaged that some or all of the school, class, and student data may be imported into system 100 directly from the school's administration databases and software. In this case, the data will not have to be entered manually as shown in FIGS. 14, 15, and 16.

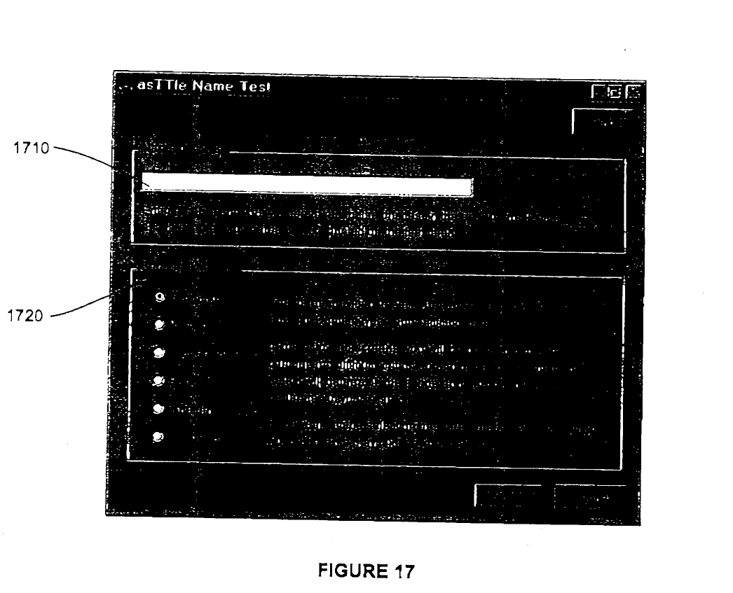

FIG. 17 shows an example user interface that may be presented to a user when they select the create test option 1320 from the welcome screen shown in FIG. 13.

The user is asked to select a curriculum for the test at 1720. In this example, the user has selected Reading. In some cases, especially where curricula are related as is the case with Reading and Writing for example; the user, may be able to specify more than one curriculum to be included in the assessment test.

The user is also asked to name the test at 1710. Although not shown in FIG. 17, the user may also be asked to specify the Grade to which the assessment will be administered. In this case the target Grade is Year 6.

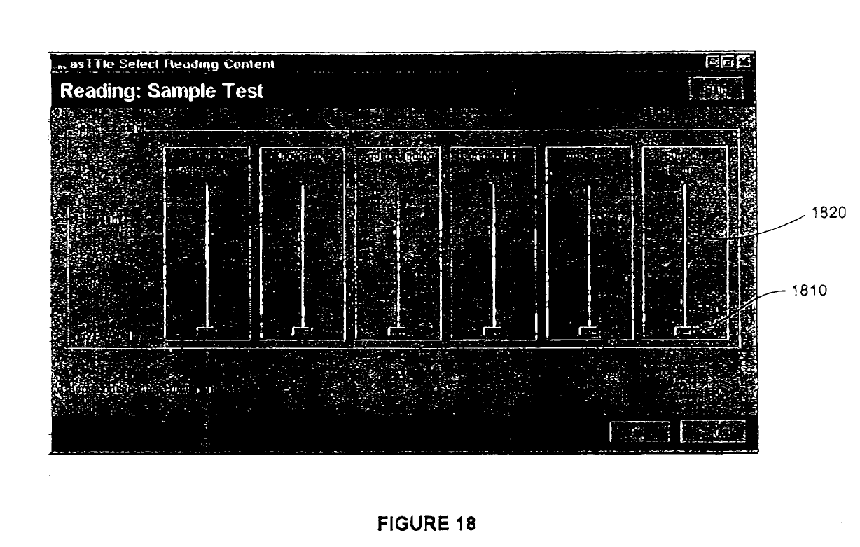

In the case where only one curriculum is to be included in the test the user may then be asked to specify which curriculum functions within the specified curriculum they would like to focus on as shown in FIG. 18 for the Reading curriculum.

If more than one curriculum is to be included in a test the user will be first asked to specify a weighting for each curriculum indicating the proportion of the assessment test to be dedicated to that curriculum. The user will then be asked to specify the curriculum functions to be included for each curriculum individually.

As shown in FIG. 18, the user may specify the number of question items they would like to include in the assessment test by moving a slider tab, for example, 1810 for each curriculum level to a position on a slider, for example 1820, between “very few/none” and “most” as shown. This amounts to providing a proportional weighting indicating the extent to which each curriculum function should be assessed in the test.

In a particularly preferred embodiment the number of curriculum functions that a user can select for assessment will be limited to a reasonably small number so that the assessment may be focussed accurately and so that the results will be meaningful. In the example shown the user is limited to three curriculum functions for each assessment test.

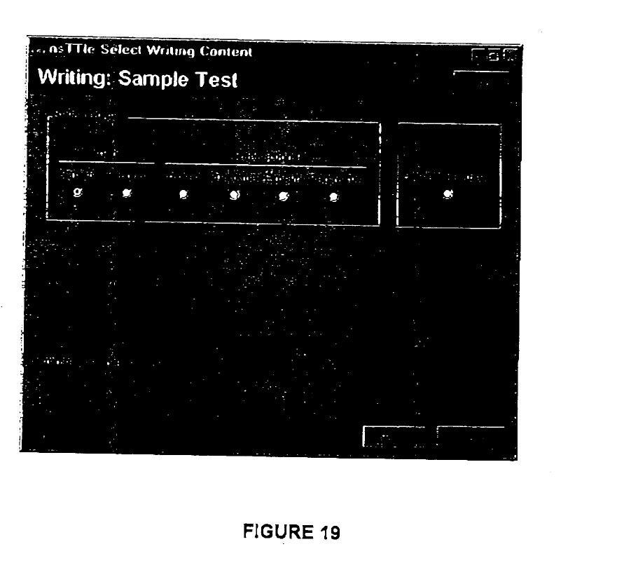

FIG. 19 shows another example interface for entering curriculum functions, this time for the example Writing curriculum. In a preferred embodiment only one curriculum function may be included in a test for the Writing curriculum as shown.

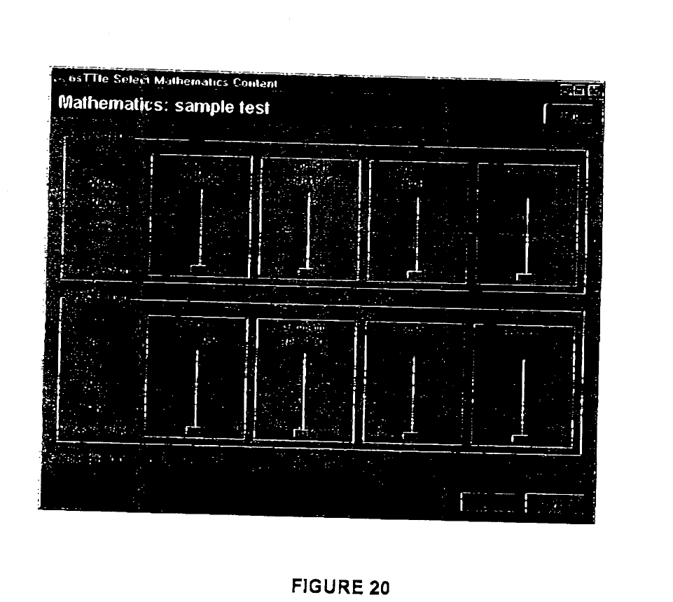

FIG. 20 shows an example interface for entering curriculum functions for an assessment for the Mathematics curriculum. As with the example for Reading shown in FIG. 18, the user is encouraged to select only three curriculum functions for a single test and may weight the functions by moving a slider to indicate the user preference for the proportion of questions for each curriculum function.

Once the curriculum functions for an assessment test and the preferred weightings for each function within the test have been set, the user may be asked to give a provisional assessment of the curriculum levels at which the students to be assessed are functioning.

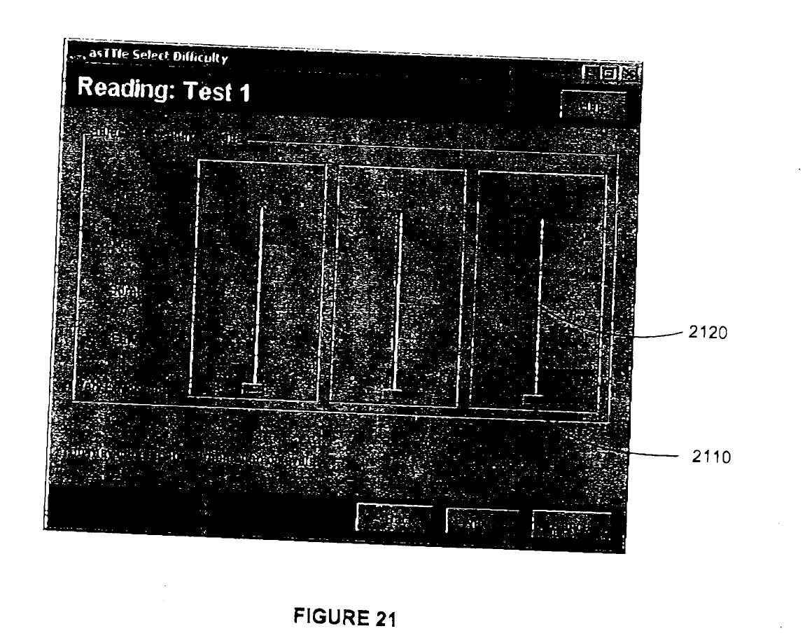

An example interface for this is illustrated in FIG. 21. If the test is for a Year 6 class as suggested above, the curriculum levels at which the students in the class are likely to be functioning are curriculum levels two to three. The user is asked to estimate the proportion of students in the class functioning at each of these levels for the selected curriculum(s).

The user may, for example, move a tab 2110, up or down a slider 2120, as indicated in FIG. 21 to set the class proportions for curriculum levels.

The various criteria entered by a user for a test as shown in FIGS. 17 to 21 and described above may be referred to as a test specification. The step of obtaining a test specification from a user is shown at 440 in FIG. 4.

Once all the necessary data has been received from the user as described above, the invention will generate a test by selecting question items from the item bank(s) that meet the criteria for the test as entered by the user. This step is shown at 450 in FIG. 4.

The process of generating a test is one whereby the invention selects test items which, when put together into a test meet as closely as possible the test specification entered by the user.

As with the calibration of test items to curriculum levels, the generation of tests for a particular curriculum level may be at least partially based on Item Response theory models and in particular on Test Information Functions as described below.

Item information provides an indication of item measurement precision from which items can be selected into the test on the basis of their information.

Item information curves can be added together to define a Test Information Function which is simply the sum of the Item Information Curves for each item included in the test. The Test Information Function may be expressed as follows:

$${I}_{i} ( θ ) = {\sum }_{i = 1}^{n} {I}_{i} ( θ ) ,$$

where I(θ) is the amount of test information at an ability level of θ, I, (θ) is the amount of information for item I at ability level θ, and n is the number of items in the test.

Clearly the Information Functions for items and particularly tests can equally be used to define targets as to what information the items in the test and the test itself should ideally provide. Therefore the test specification can be rendered as a Target Test Information Function and the curve of the Target Test Information Function compared with the Test Information Function of any test that is generated to determine whether the test generated meets the test specification.

The present invention is capable of producing a test whose information curve is as close as possible to the Target Test Information Curve while also conforming to one or more practical constraints such as test time constraints, target curriculum function constraints, item usage constraints and so on.

Each test has one or more target attributes as captured in the test specification An attribute might be Content (Curriculum function(s)), Difficulty (curriculum level(s)), Surface, Deep, Usage, or Open-ended. Each attribute defines the proportion of items to be included in the test with particular characteristics.

In order to generate a solution the structure of the item bank needs to be considered. The preferred structure of the item bank of the invention is a composition of set-based items (or testlets). That is, groups of items may be linked to a common stimulus and as a result are set-bound. For example, a number of comprehension questions may be linked to a single reading text. The implication is that if certain items are selected then the associated stimulus should also be selected, or vice versa.

The item bank of the invention therefore effectively comprises a plurality of testlets, each testlet being associated with a number of items that could potentially be included in the testlet. One or more of the items will form the core of the testlet (the stimulus item for example) and must be included in the testlet if it is to be used Non-core associated items may also be added to the testlet but are not essential for the testlet to function.

Several preferred methods for implementing the method, system and computer program of the invention are described below. It will be understood that alterations and alternatives with the same effect may be used without departing from the preferred embodiments of the invention.

As previously described, a user may enter a plurality of preferred attributes of the test such as the proportion of questions to be devoted to items targeted to one or more curriculum functions or at one or more curriculum levels.

For example, a user may set the content sliders to enter the proportion of items the user would like to be directed to particular curriculum functions (content). The user may also enter proportion information for difficulty levels as described above. These values are referred to as the weight for the attributes. In order to set these weight values the user may choose from a number of options for each attribute such as Most, Many, Some, Few, and None as described above.

In the underlying implementation the weight values may have numeric equivalents that can be used in generating the test. Preferred numeric weight values for the user-entered word-based quantifiers are listed below.

Most=90

Many=70

Some=40

Few=20

None=0

Other attributes that may need to be considered include the number of times an item has already been used (usage factor), or whether the test is to include open-ended questions (open-ended).

Each attribute of the test specification will need to be quantified numerically in order to generate a test that meets all requirements. The target “usage factor” of all items in the test is preferably zero by default (ie the item should have never been used before). The actual usage factor of an item will be calculated to be the number of times an item has been used, up to a maximum value of 4, multiplied by 60.

Upon receiving the test specification the invention may preselect a number of testlets and items that are appropriate to the user inputs in the first instance. It is envisaged that testlets as well as items will be flagged to identify their content and difficulty. It is also envisaged that all items will have a time attribute that indicates the projected time required for a student to complete the item.

For those attributes with user entered weight values such as content and difficulty, a lower bound will need to be calculated. For some attributes the lower bound will be set by default. For example, the lower bound for item usage is zero as described above.

Generally the lower bounds for an attribute will be set to be the amount of time in the test that should be devoted to items that fulfil the attribute criteria provided that this value never exceeds the total time allowed for the test, and is never less than any minimum values that may be set by policy. For example it is preferred that the minimum number of items included for any selected curriculum function is five.

Numeric θ values are derived for the 20 ability levels from ability levels 2a to 4b described above.

The Target Test Information Function is then constructed and a value calculated for the target information function at each of the 20θ values using the Information Function equation described earlier. Each Target Test Information Function value is stored together with its corresponding θ value. These pairs may be referred to as the “target pairs”.

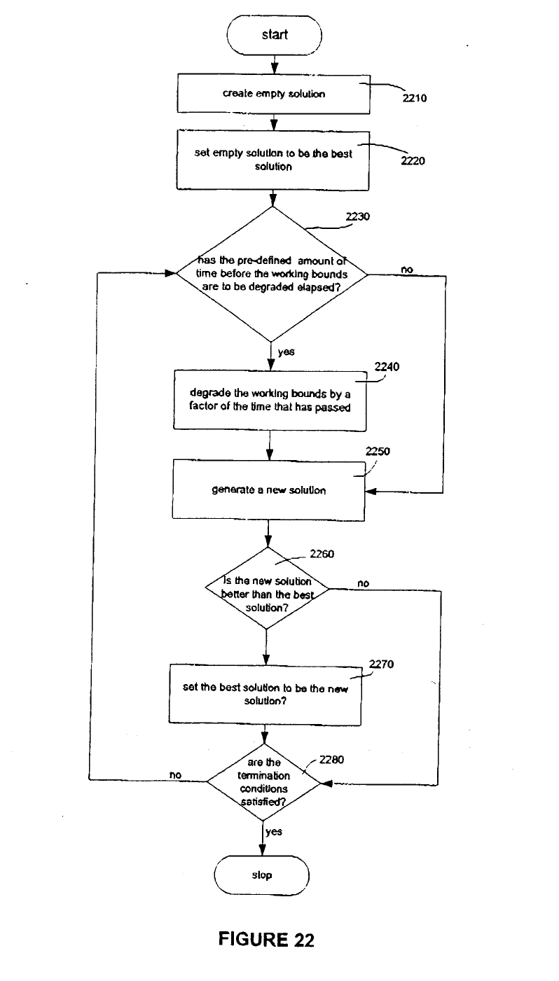

From this point the basic procedure for the invention is set out in a flow chart in FIG. 22 and is to create an empty solution (a test) 2210, define this solution to be the best solution 2220 and then generate a new solution 2250. The new solution is compared with the best solution 2260. If the new solution is better than the best solution the new solution becomes the new best solution 2270. This procedure is repeated starting at the point where a new solution is generated until the termination conditions are met. FIG. 22 is a flow chart of this procedure.

A plurality of time limits are defined to assist in determining when the procedure described above should terminate or to be modified. The various factors involved in deciding when to terminate are described below and may be referred to as termination conditions as shown in FIG. 22. A maximum and minimum runtime will be defined for this purpose.

In between the maximum and minim runtimes there may be another pre-determined time limit after which the working bounds of the attributes are degraded on each repetition of the basic procedure described above (2230, 2240).

If the working bounds are to be degraded then for each attribute (except usage) for which the lower bound is greater than the sum of the attribute of the best solution, the working lower bound of the attribute should be set to be the lower bound of the attribute multiplied by the maximum runtime minus the time already elapsed.

The basic procedure will terminate when the minimum runtime has elapsed if the time limit after which the working bounds are degraded has not yet passed and the best solution is feasible. If this is not achieved then the procedure will terminate after at least a pre-determined minimum time has elapsed after the time limit after which the working bounds are degraded as long as the best solution is feasible. These time limits contribute to the conditions for the procedure illustrated in FIG. 22.

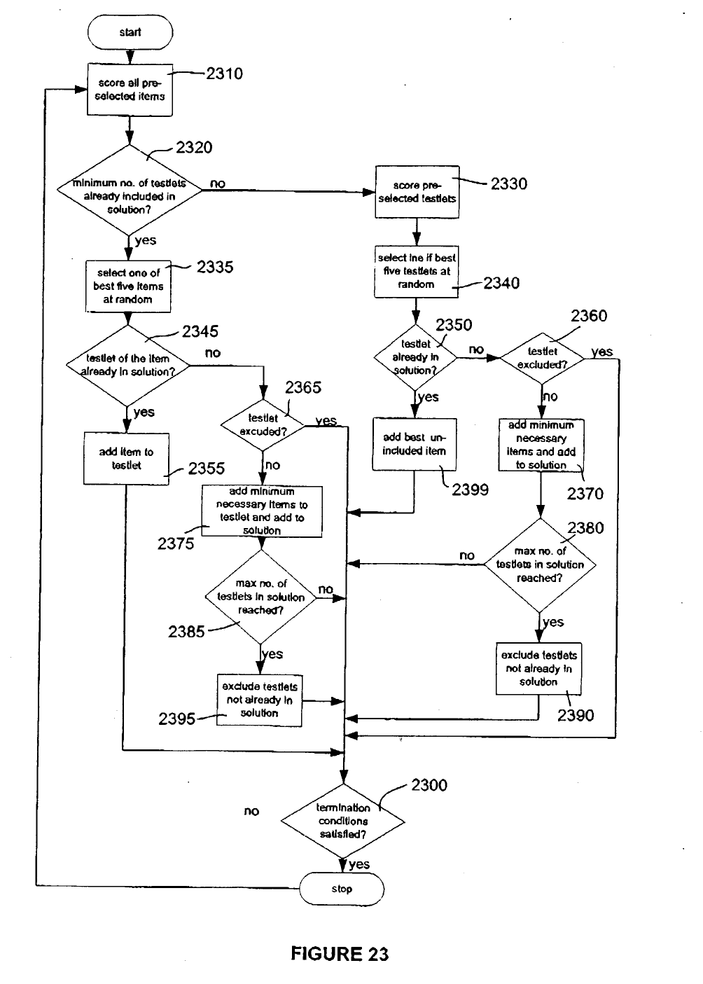

One preferred method of generating new solutions is described below. This method is illustrated in the flowchart of FIG. 23. The first step is to score all the pre-selected items in the item bank according to their suitability for the solution for example according to usage, content, and difficulty attributes. Items that are already included in the solution are excluded from consideration. This step is shown at 2310.

If a pre-defined minimum number of testlets is not yet included in the solution as determined at 2320 then each pre-selected testlet is scored according to the sum of the scores of its associated items divided by the minimum number of items that must be included in the testlet at 2330. The invention will then select one of the top five scoring testlets at random 2340.

If the testlet has not been included in the solution as determined at 2350 and the testlet is not excluded as determined at 2360 then no items will have been added to it. In this case the testlet is added to the solution and the associated core items for the testlet added to it 2370. Also added to the testlet are the best scoring associated items that are not core items that will make up the minimum number of items recommended for a single testlet.

When a testlet is added to a solution a check should be performed to see whether the maximum number of testlets for the test has been reached 2380. If the maximum has been reached then all testlets that have not already been added to the solution should be excluded from future consideration for this solution 2390.

If on the other hand the randomly selected testlet is already populated with items and is included in the solution then the invention will add the best non-included item for that testlet to the solution 2399.

If the testlet has a sufficient number of testlets for a test as determined at 2320 then the invention will select one of the best five items at random 2335 and if the item's testlet is already included in the solution as determined at 2345 it will simply add the item to the testlet 2355 and thus the solution otherwise if the item's associated testlet has not been included in the solution and the testlet has not been excluded as determined at 2365 it will add and populate the testlet with the necessary items as described above but including the randomly selected item 2375.

As above, if a testlet has been added to check is made as to whether the maximum number of testlets has already been added 2385, and if it has then all non-included testlets are excluded 2395.

The process of scoring available item and adding items and testlets to the solution is repeated until the total amount of time necessary for an examinee to complete the test reaches a pre-defined maximum or if the total time for the test is less than the predefined maximum then the solution generation process will stop either if there are no more items to choose from or if the total time for the test is over a pre-defined minimum and the solution is judged to be feasible. These are the remaining termination conditions for the process as shown in FIG. 23 and are assessed at 2300.

A preferred method of scoring the pre-selected items is set out below. The first step is to exclude all items that have already been included in the solution and all those items that were not pre-selected. The scoring process should be conducted on each non-excluded item in the item bank.

If all the target attributes required for the test are not satisfied then the initial item score for each non-excluded item is set to be the value of the usage variable of the item multiplied by the weight of the usage attribute. Then for all non-zero attributes (except usage) a value equal to the weight of the attribute multiplied by the higher of zero and the working lower bound of the attribute is added to the item score.

If the item satisfies both the curriculum function and curriculum level constraints set by the user then the score may be multiplied by ten to make it a more attractive choice for inclusion.

A preferred method for determining whether an item satisfies the curriculum function and curriculum level attributes for a solution is set out below. If all the target attributes of the test haven't been satisfied, this is basically a two-part test and the item must satisfy both parts of the test for the result to come out true.

The first part of the test will give a true result either if the contents of the item meets the unsatisfied curriculum function target attributes or if the there are no unsatisfied curriculum function attributes.

The second part of the test will give a true result either if the curriculum level of the item meets the unsatisfied curriculum level target attribute or if there are no unsatisfied curriculum level attributes.

Alternatively if all target attributes of the test have been satisfied then the result for the item will be true if the item's curriculum function corresponds with any curriculum function attribute of the test specification and the item curriculum level is in one of the selected curriculum levels.

A preferred method of determining the quality of a solution produced by the invention follows. Determining the quality of a test solution is basically about finding the maximum difference between the Test Information Function of the generate solution and that of the ideal “target solution.” Ideally, the difference between the Test Information Function of the generated solution and that of the target solution should be zero. The best of two generated solutions will be the one for which this difference is the closest to zero as long as both solutions are feasible. This is the test which is carried out at 2260 in FIG. 22.

Test information Function values for the target solution are already stored in the target pairs described above together with their corresponding θ values.

For each θ in the target pairs the invention calculates a sum of the Item Information Functions as set out in the equation above where θ is the θ of the target pair under consideration and b is the curriculum level or difficulty of the item. The absolute value of the difference between this sum and the Target Information Function value for that θ in the target pairs is then added to the um difference. The smaller the maximum difference value is once all of the target pair θ values have been considered the better the solution is considered to be.

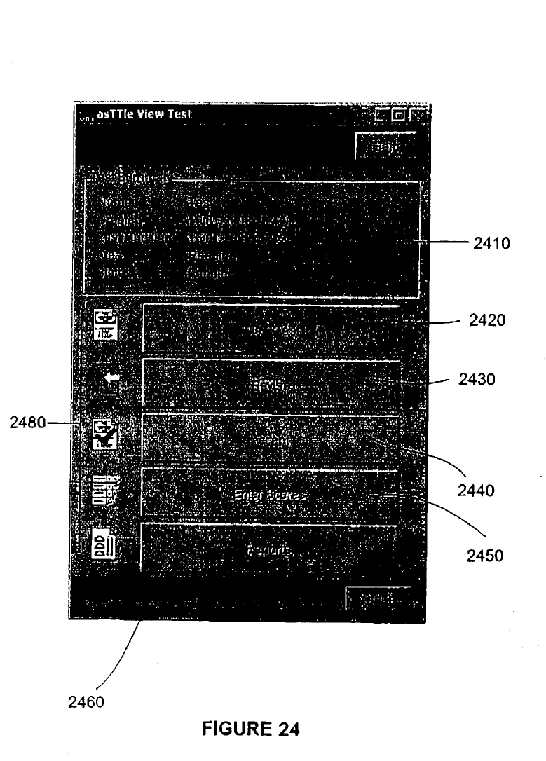

Once a test is generated the user can access the test via an interface as shown in FIG. 24. An interface such as that shown in FIG. 24 may be accessed immediately after the test is generated by the invention or may be accessed by selecting the manage tests option 1330 from a main menu such as that shown in FIG. 13.

The example interface shown in FIG. 24 gives basic information about the test in the form of a summary 2410 and gives the user the options of viewing the test 2420, revising the test 2430, accepting the test 2440, entering student scores from the test 2450, and generating reports of student performance for the tests 2460. The user may access these functions via menu buttons 2420 to 2460 or via icons 2480.

The View Test option 2420 gives the user the opportunity to review the test generated by the invention and decide whether the test is appropriate for the target group of students. If not, the user may use the revise option 2430 to change any of the criteria specified for the test such as those shown in FIGS. 17 to 21.

It is a particularly preferred aspect of the invention that the user is not able to hand-select the items to be included in a test but can only customise the assessment by providing and modifying the test specification data This enables the assessment to remain impartial and standardised.

Once the user is satisfied with the test they may elect to accept the test 2440 which is then entered into the system and prepared to be administered to the students.

In its most preferred form the test will comprise an electronic file made up of text and images that may be printed and administered to students as a paper and pen/pencil test. Although any appropriate form of administration may be used.

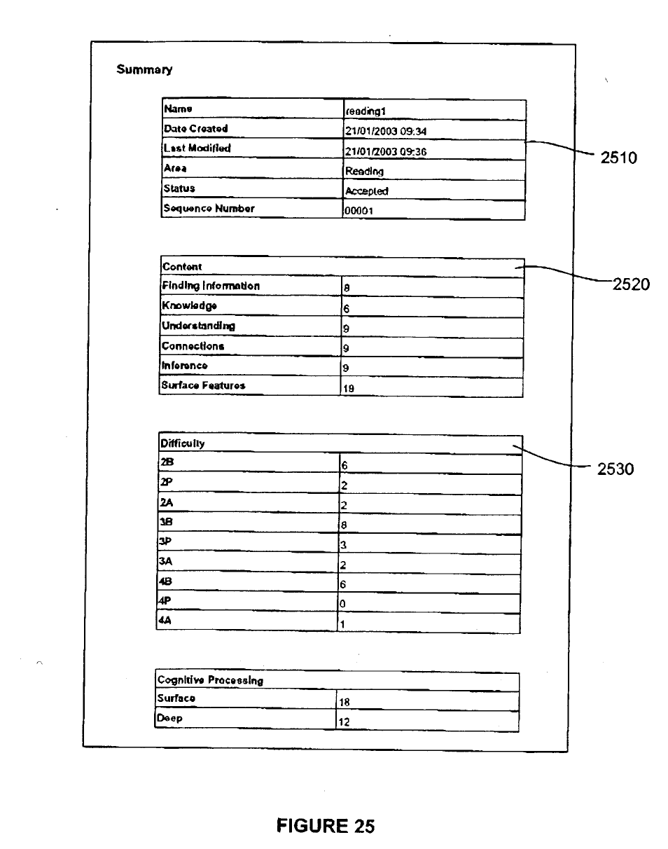

The test as reviewed or printed may contain a summary page as shown in FIG. 25 for the reference of the user administering the test. The summary may contain basic information 2510 such as the name of the test, the curriculum to be tested (in this case reading) and the date created. The summary may also contain a summary of the number of question items selected for each of the curriculum functions as shown at 2520. The summary may also contain a breakdown of the number of questions aimed at each curriculum level and sublevel 2530.

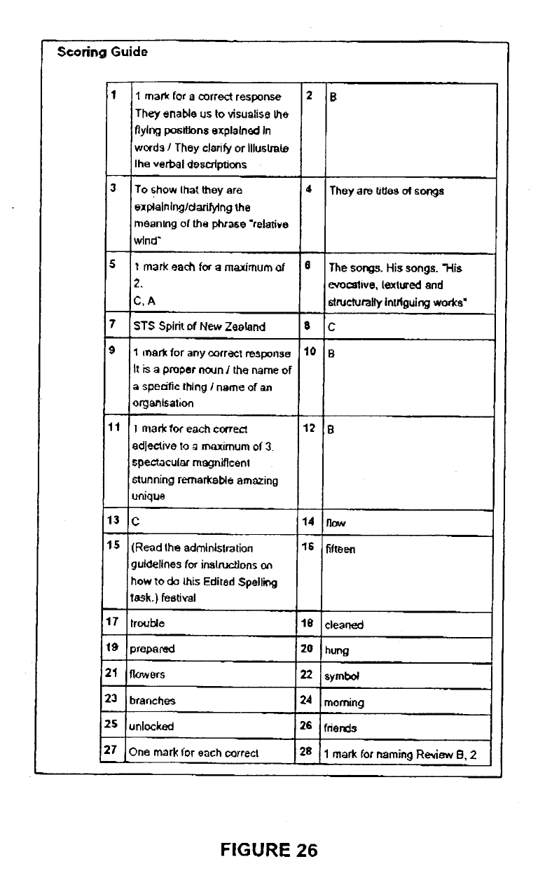

The test as reviewed or printed may also contain a scoring guide for the reference of the user administering the test such as that shown in FIG. 26.

The test may also contain notes for administering the test for the reference of the user administering the test.

If the test is the first such test administered to the students they may be asked to complete a cover page with some information about themselves. Of particular usefulness is information about the ethnicity of each student and whether the student speaks the language of instruction—in this case English—or another language at home. This information is useful for the later generation of reports and may not necessarily be available via school records. Any data obtained in this way should be entered into the student profile before any reports are generated.

Even if the students have taken a similar test in the past they may be asked to rate their “attitude” to the curriculum subject on a scale from positive to negative every time they take a test. This information will allow a user to compare a student's attitude to a subject with their progress and achievements.

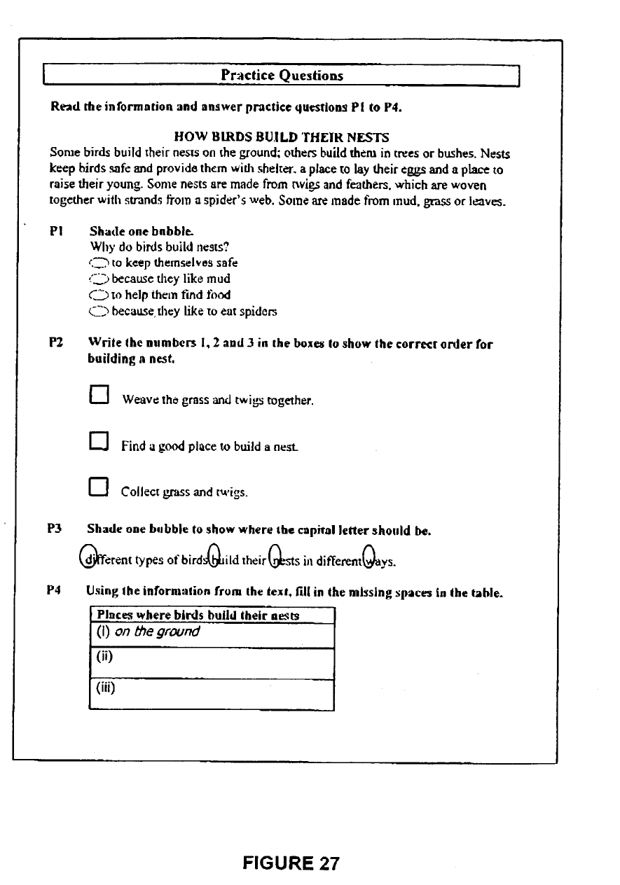

For some curricula the test may include one or more practice questions so that the student can work through and get a feel for the style and requirements of the test. Sample practice questions for the Reading curriculum are shown in FIG. 27.

Finally, the test will comprise the test questions selected from the item banks. The test questions will be automatically formatted to follow each other in a logical way and to fit easily onto the pages of the test.

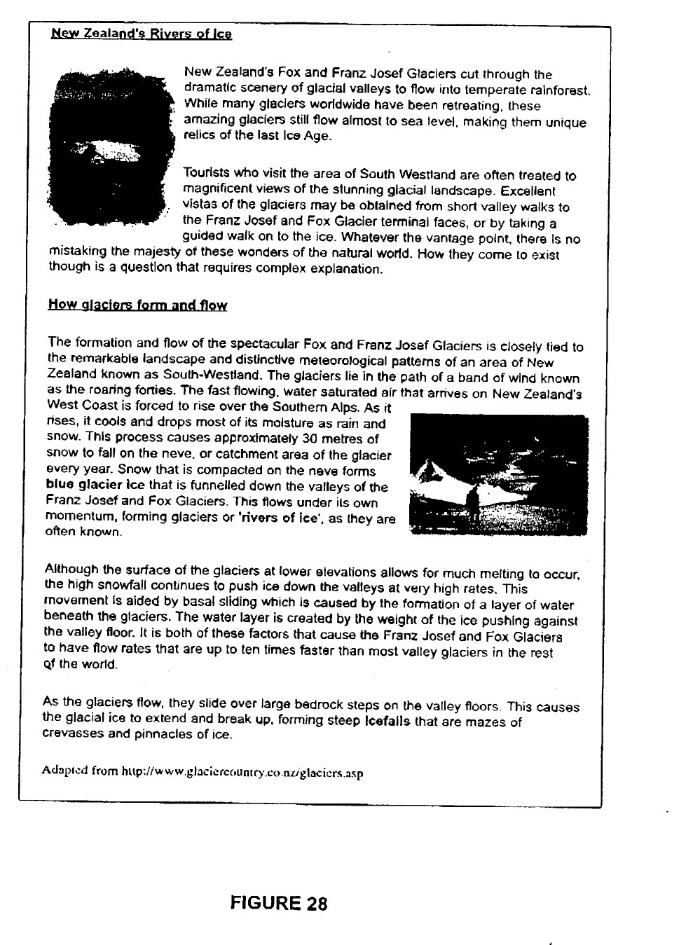

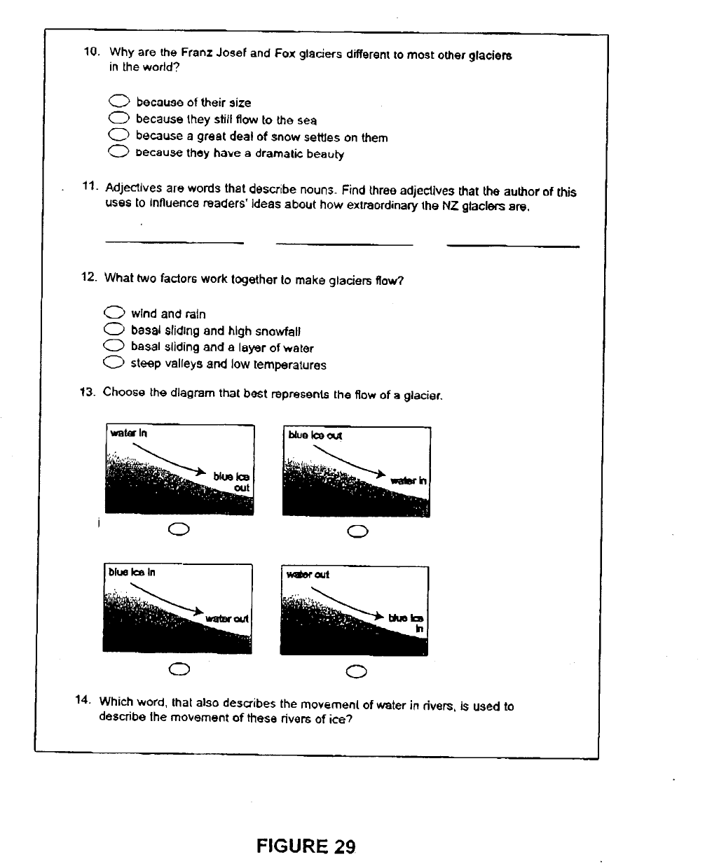

For a Reading curriculum test several texts such as that shown in FIG. 28 may be used. Typically the test item bank will contain a relatively large number of test items related to a single text, each test item focussing on different curriculum functions and curriculum levels or in other words, each testlet as defined above with a single stimulus (in this case a text) may be related to a large number of items for potential inclusion and rose items may have different levels of compatibility with the attributes stipulated in the test specification. The test items related to a text to be included in a test will be selected based on the criteria entered by the user as described above. The invention will automatically sequence the selected test items from easy to more difficult and number them appropriately. Sample questions for a Year 6 reading test using the text from FIG. 28 are shown E FIG. 29.

Test items and texts selected for inclusion in a test for a particular group of students will be flagged for that group once the test is accepted by modifying the usage factor of the items and testlets. Preference will be given to texts and question items with lower usage factors when subsequent tests are generated for that group, as described above. The same will be true of other types of test items and supplementary materials incorporated into tests for other curricula. For this reason a reasonably large item bank is recommended for each curriculum.

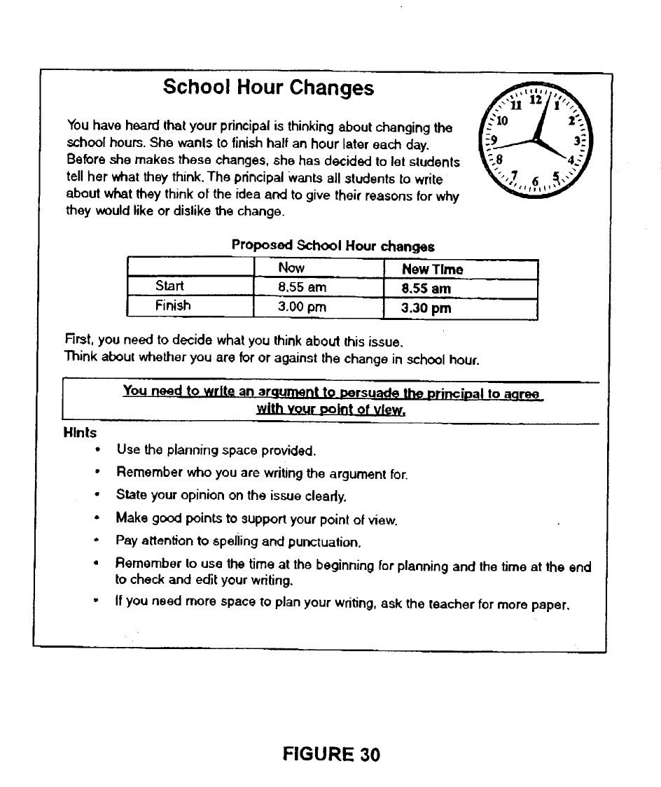

FIG. 30 shows an example of a test question for a Writing curriculum test. This test item may be calibrated to assess the curriculum function “to argue or persuade”. This test is intended to be administered to a class of Year 6 students.

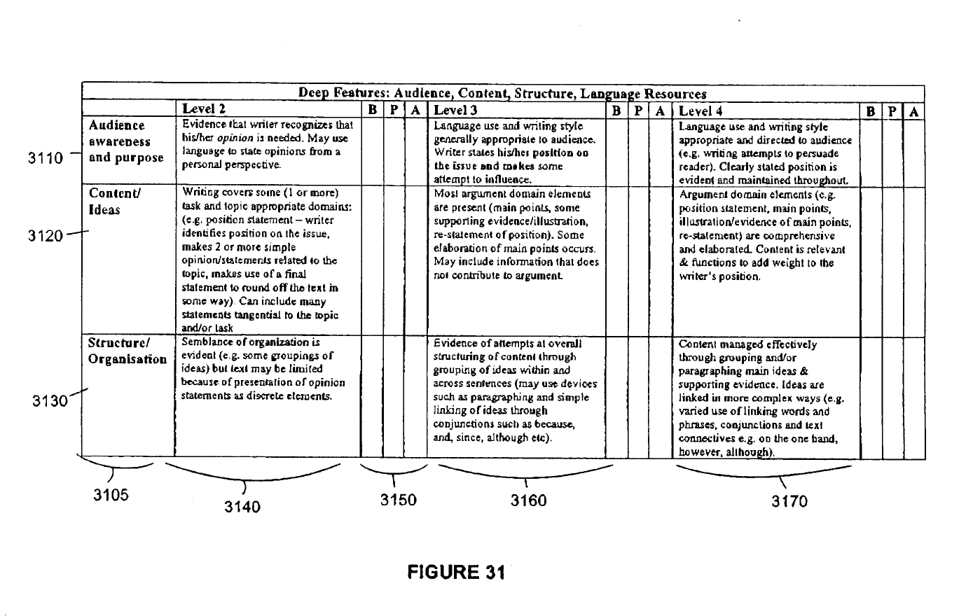

In an open-ended question like this it is important that the analytic bases for relevant curriculum levels for the curriculum function are well defined in the scoring guide as are the analytic bases for any curriculum sub-functions. FIG. 31 shows an example page from a marking guide for the Reading curriculum test shown in FIG. 30 aimed at the curriculum function “to argue or persuade”.

Curriculum sub-functions to be evaluated are listed down the left hand column 3105. The curriculum sub-functions set out in FIG. 31 include Audience awareness and Purpose 3110, Content and Ideas 3120, and Structure and Organisation 3130. For each of these sub-functions the scoring guide sets out the performance expectations for each of the most likely levels into which the students in the group will fall namely curriculum levels 2 to 4, The performance objectives for curriculum level 2 are set out in column 3140. Within this level the user must then determine whether the student's level of achievement is basic, proficient, or advanced as shown at 3150. The performance objectives for level 3 are set out in column 3160 and the performance objectives for level 4 are set out in column 3170.

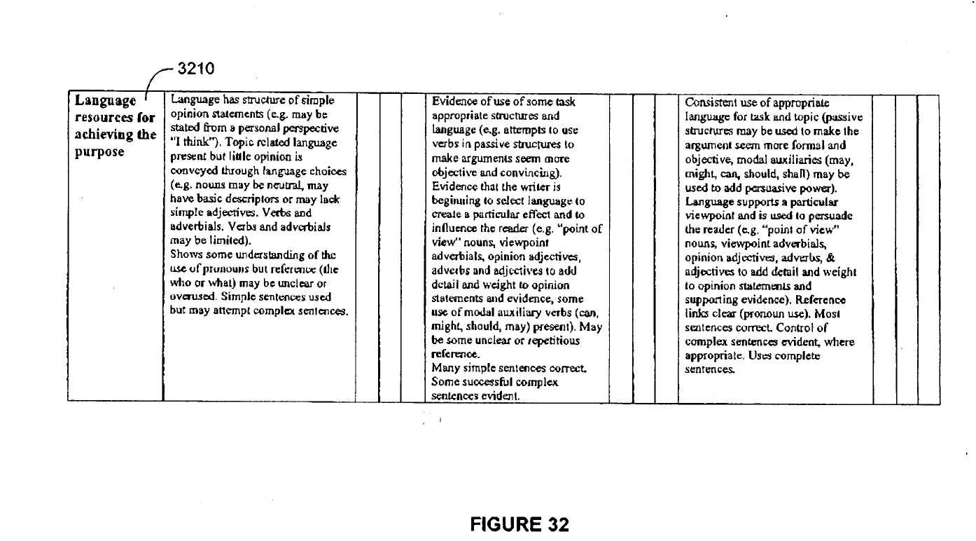

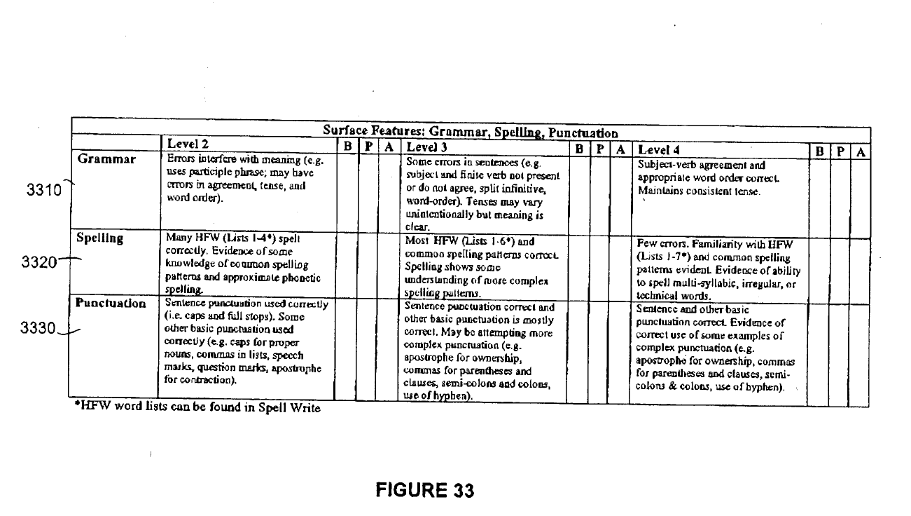

FIG. 32 shows the section of the example marking guide from FIG. 31 for the curriculum sub-function “language resources for achieving the purpose” 3210. FIG. 33 shows the section of the example marking guide from FIG. 28 for the curriculum sub-functions “Grammar”, “Spelling”, and “Punctuation” from the “Surface Features” group.

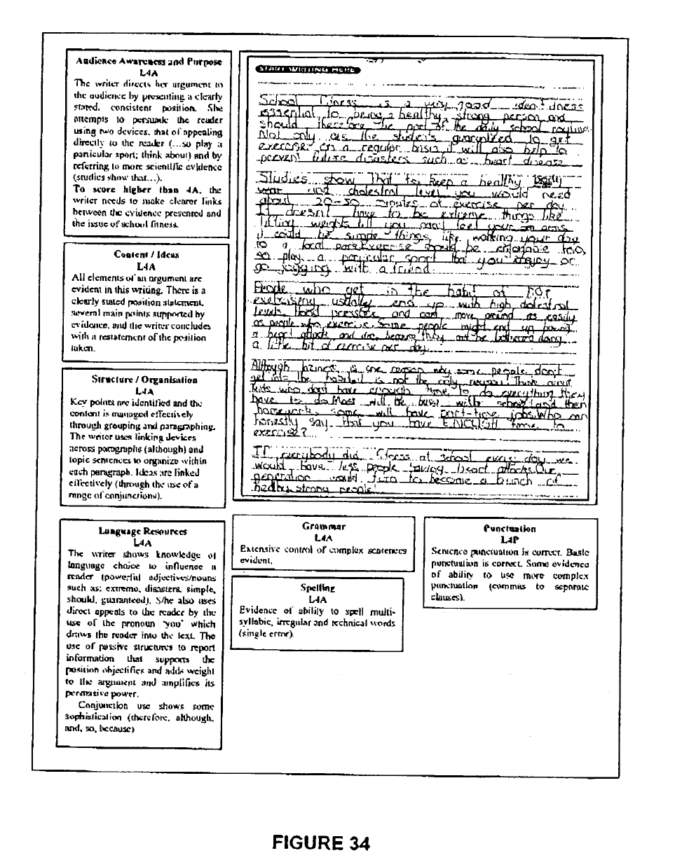

For open-ended questions such as the Writing question illustrated in FIG. 30, the scoring guide may also incorporate a sample answer with example scoring shown. Such a sample answer with scoring samples is shown in FIG. 34.

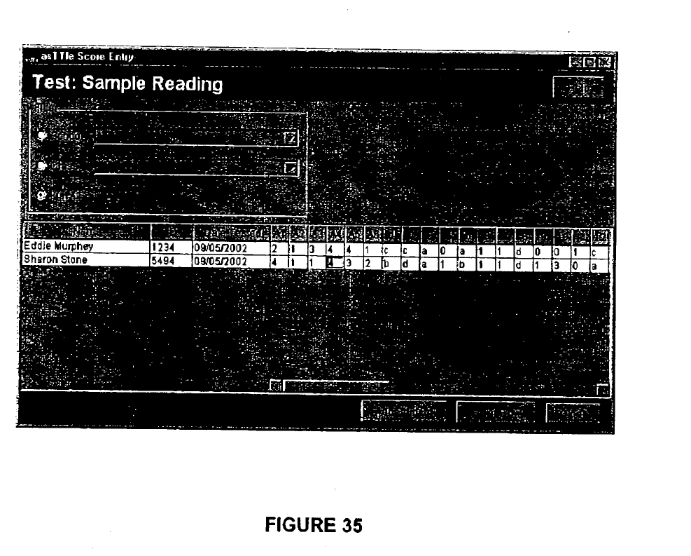

After the test has been administered to the students, as shown at 460 in FIG. 4, and scored according to the scoring guide, the user must enter the scores for each student into the system 100. FIG. 35 shows an example interface configured to allow a user to enter the scores for each student into the system. Scores for each question in the test should be entered separately as shown. Where the question was in multiple choice format the students answer may be entered directly. The steps of scoring and entering the scores of a test into the system 100 are shown at 470 in FIG. 4.

Storing the scores for each question separately allows the system to analyse the results with regard to the curriculum levels at which the student is performing for the different curriculum functions and which curriculum functions represent a strength for the student in that curriculum and which curriculum functions represent a weakness for the student.

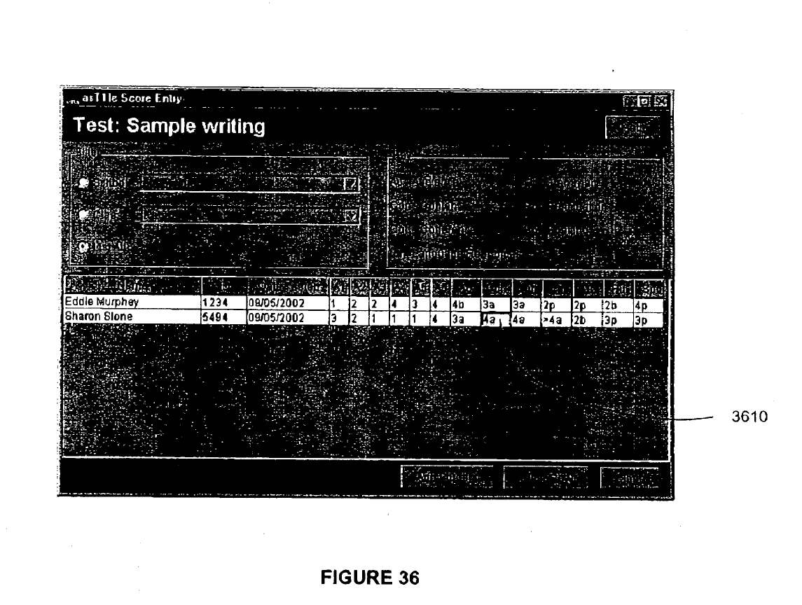

FIG. 36 shows a further example interface configured to allow a user to enter the scores for an assessment test. This test comprises a writing component and the scores entered for that component are based on the levels and sub-levels determined by the user for each curriculum sub-function by using a scoring guide such as that shown in FIGS. 31 to 33. For example score 3610 in FIG. 36 indicates that Sharon Stone is performing at curriculum level 4A in her performance of the “Content” curriculum sub-function.

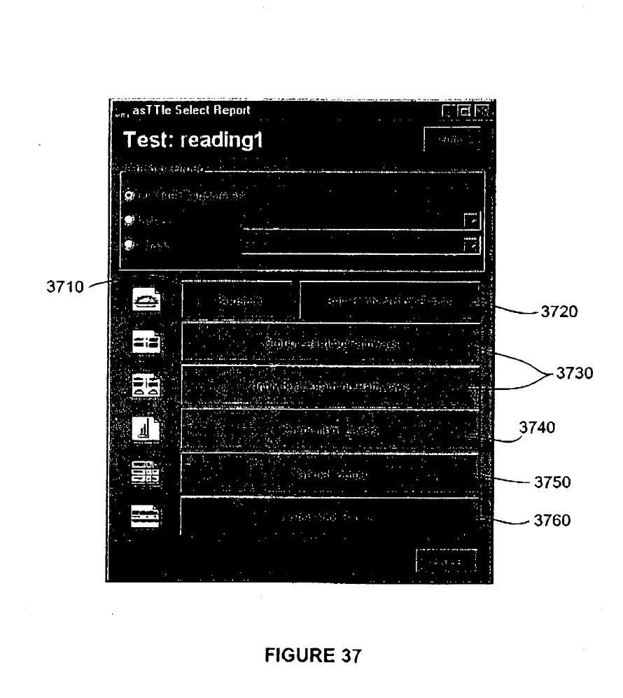

After the scores for at least one test have been entered the user may access the reporting functionality of the invention and generate one or more reports as shown at 480 in FIG. 4. The reporting functionality of the invention may be accessible via the “manage tests” option 1330 from the welcome screen shown in FIG. 13. One example interface configured to allow a user access to the reporting functionality of the invention is shown in FIG. 37.

The invention may be configured to produce a number of different reports including reports that are externally referenced to data representing the performance of a representative sample of comparable students in relation to test items targeted to particular curriculum levels and curriculum functions in the same way as the question items of the invention. This data may be referred to as representative sample performance data 350 and will be stored in the system 100 for immediate access by the report generation functions of the invention as shown in FIG. 3.

The representative sample performance data is preferably organised so that the performance data may be extracted and used as a basis for comparisons either as a whole or specifically from student groups and schools that meet particular criteria. For example, comparative report data may be available specifically from representative groups and representative students from schools in particular geographic areas, schools of a particular size, schools with a particular proportion of minority students, urban schools, rural schools and schools with a particular decile rating. Results may also be available specifically for representative female students, male students, students of a particular age, students of a particular ethnicity, students in particular grades, or students who do not speak the language of instruction at home for example. Any combination of school and students group may also be possible. For example representative data for female students in rural schools may be extracted and used as a basis for comparing data from the results of a user's own students or for a particular student.

One report that may be generated by the invention is primarily aimed to provide the user with comparative and normative information about the results of an assessment test for a group of students. This type of report may be referred to as a console report and may be accessed by selecting the console report option 3710 from the interface in FIG. 37.

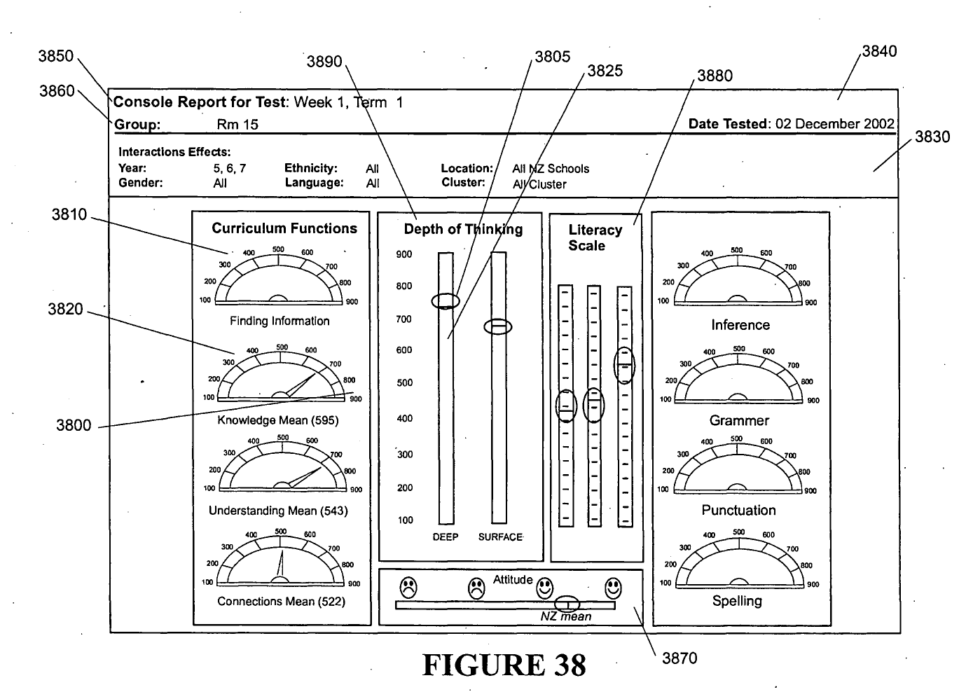

An example console report for a Reading test is shown in FIG. 38. The report shows the name of the test being reported 3850, the class group that took the test 3860, and the date of the test 3840. This basic type of information is common to most of the report types.

The report also illustrates the performance of the student group for each of the curriculum functions assessed. The curriculum functions may be represented as individual dials, for example 3810 for the “finding information” curriculum function and 3820 for the “knowledge” curriculum function. However, those curriculum functions that were not assessed by the test are greyed out like that for the “finding information” curriculum function 3810 for example.

For those curriculum functions that were assessed the in test, the corresponding dial will indicate the group achievement levels such as is indicated on the dial for the “knowledge” curriculum function 3820. The dials on the example report in FIG. 38 start at 100 and go to 900. The national norm (or mean) is calibrated to be at 500 on the dial. Dial 3820 illustrates that the mean achievement for Reading “Knowledge” for his group was 595. Areas on the dial may be colour coded to emphasise achievement bands.

The console report may also provide information regarding the attitude of the students in the group with regard to a national norm as extracted from the representative sample performance data and shown at 3870, the depth of thinking levels for the students of the group with regard to a national norm as shown at 3890, and the levels of achievement for important curriculum specific goals such as literacy levels for the group with regard to a national norm as shown at 3880.

For measurements such as those mentioned above, a bar-type graph may be used to indicate the national norm with the coloured area 3825 indicating the levels for the national norm and a circle 3805 indicating the mean level for the students in the group. Since the levels of the group may cover quite a range, the size of the circle encircling the mean score for the group gives an indication of the degree of standard error of measurement in the mean score. The mean levels indicated in a group console report by their nature are not inclusive of all students in the class.

A console report may also be generated for the results of an individual student rather than basing the report on the mean achievement for a whole class or group.

The representative sample of students from which the comparative norms being used are taken is indicated at 3830. In this example the achievement of the students in this group are being compared to a representative sample group of students in Years 5, 6, and 7, across all genders, all ethnicities, students of all native languages, students from schools in all locations and schools of all descriptions.

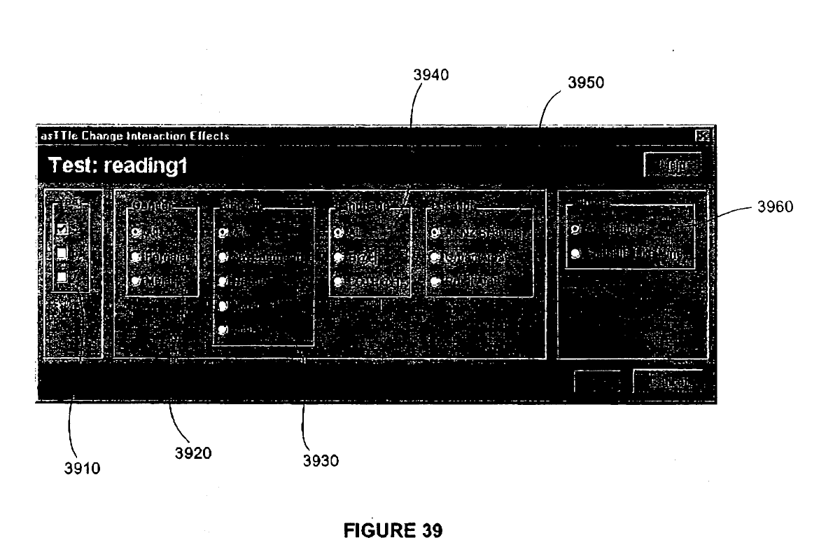

Typically a user will want to compare their students to specific other sub-groups of students whose performance is represented in the representative sample performance data. If the user wishes to access a more targeted comparative norm the user may select the select interaction effects button 3720 from die example interface shown in FIG. 37. An example interface that may be used to target sub-groups from the representative sample performance data is used to provide the comparative norms for the reports is shown in FIG. 39.

While the invention could allow the user to target the representative sample performance data for a report by focussing on any attribute of the student or class, six useful attributes to vary in the comparative report data are illustrated in the example interface in FIG. 39. The number of attributes on which comparisons may be based will be limited only by the size of the representative sample of students whose results make up the representative sample performance data.

In this example, the user may choose to compare their student or student group only to students in the same Grade as shown at 3910, the user may specify that a comparison be made only with male or female students or with both as shown at 3920, the user may specify that a comparison be nude only with students of European descent or only with students of another particular ethnicity as shown at 3930. In addition the user may wish to compare their student or student group only with native speakers of the language of instruction indicated as E@H (English at Home) in this example at 3940, with non-native speakers of the language of instruction in this example indicated by LOT@H (Language Other Than English at Home) at 3940 or alternatively with all students in the representative sample regardless of their native language. The comparative report data may also be specified with regard to the location of the school as shown at 3950, or by simply selecting the option “schools like mine” at 3960 which will automatically use comparative report data from schools with similar or identical attributes to those of the user's school to form the comparative norm for the report.

Any combination of attributes may be selected to specify an appropriate representative sample to serve as the comparative norm for the user's student or class group. The invention is not limited to the demographic attributes mentioned above.

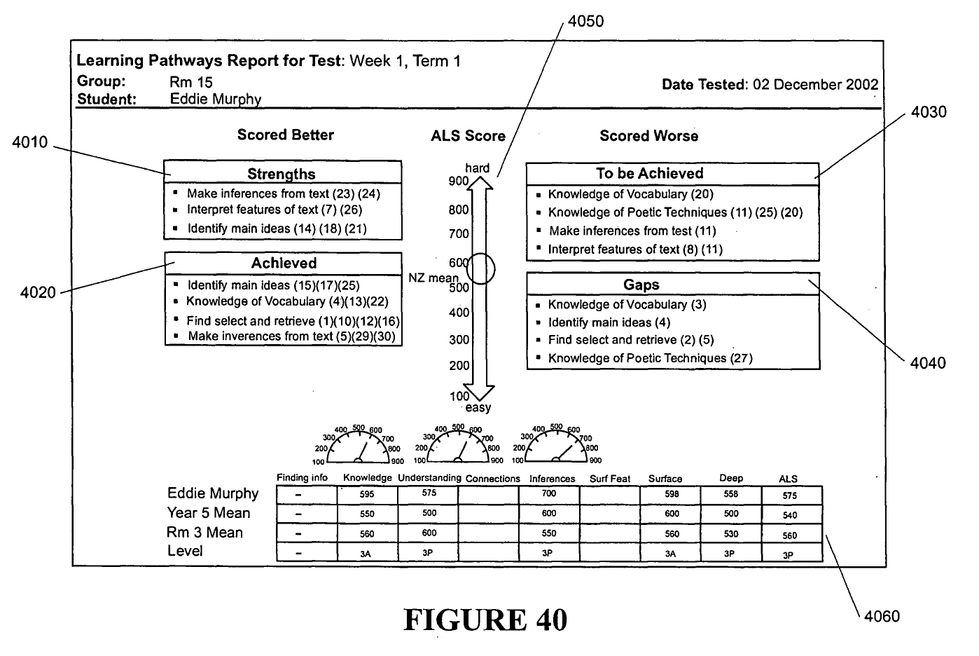

FIG. 40 illustrates a further type of report based on curriculum function benchmarks that may be generated by the invention. This type of report may be referred to as a “learning pathways” report and can be generated either for a class group of students or for an individual student. The “learning pathways” reports may be generated by selecting the appropriate button(s) 3730 as shown in FIG. 37.

The example “learning pathways” report shown in FIG. 40 represents a report for an individual student. The information presented in the learning pathways report is essentially unique to each student and is not compared to a normative or standardised group, although basic comparative information may be shown as at 4060 and 4050.

As shown in FIG. 40 the learning pathways report has four main quadrants: the Strengths quadrant 4010, the Achieved quadrant 4020, the To Be Achieved quadrant 4030, and the Gaps quadrant 4040. Inside each quadrant is a list of items identifying curriculum functions and curriculum sub-functions assessed in the test. The actual test question items that assessed each function and fit into each quadrant are listed in parentheses after the name of the function or sub-function.

Items listed in the Strengths quadrant 4010 are items that, given the student's overall score in the test, the student would have been expected to answer correctly, and the student did. This quadrant may be colour coded green, for example, a colour with ‘go ahead’ connotations to indicate that these are areas where the teacher can confidently give the student more challenging work.

Items listed in the Achieved quadrant 4020, are items that, given the student's overall score in the test, the student would have been expected to answer incorrectly, and yet the student answered correctly. These are items that the student answered correctly but which were more difficult than the estimate of the student's ability and demonstrate a student's unexpected strengths in a curriculum. This quadrant may be colour coded blue, for example.

Items in the To Be Achieved quadrant 4030, are items that, given the student's overall score in the test, the student would be expected to answer correctly, and yet the student answered incorrectly. These are items that are relatively easy in relation to the estimate of the student's ability and yet were answered incorrectly. This quadrant may be colour-coded red, for example, to indicate that this is an area that the teacher needs to investigate and either eliminate as a concern or address in a remediation plan.

Items in the Gaps quadrant 4040, are items that, given the student's overall score in the test, we would have expected the student to answer incorrectly, and the student did. These items are beyond the ability level of the student and represent areas in which the student still has to achieve and in which it is expected that the teacher will carry out more teaching. This quadrant may be colour-coded yellow, for example.

It is possible for the same curriculum feature to appear in more than one quadrant of a learning pathways report for a particular student because not all question items in a test are of the same difficulty even though they are assessing the same curriculum unction. For example, in FIG. 40 the “knowledge of vocabulary” curriculum sub-function appears in the Achieved quadrant 4020 for test items 15, 17, and 25, but appears in the Gaps quadrant 4040, for item 3. This suggests that item 3 was of a more advanced nature than items 15, 17, and 25. For this reason it is useful to have the specific test items appear in the report rather than just the curriculum function and sub-function names.

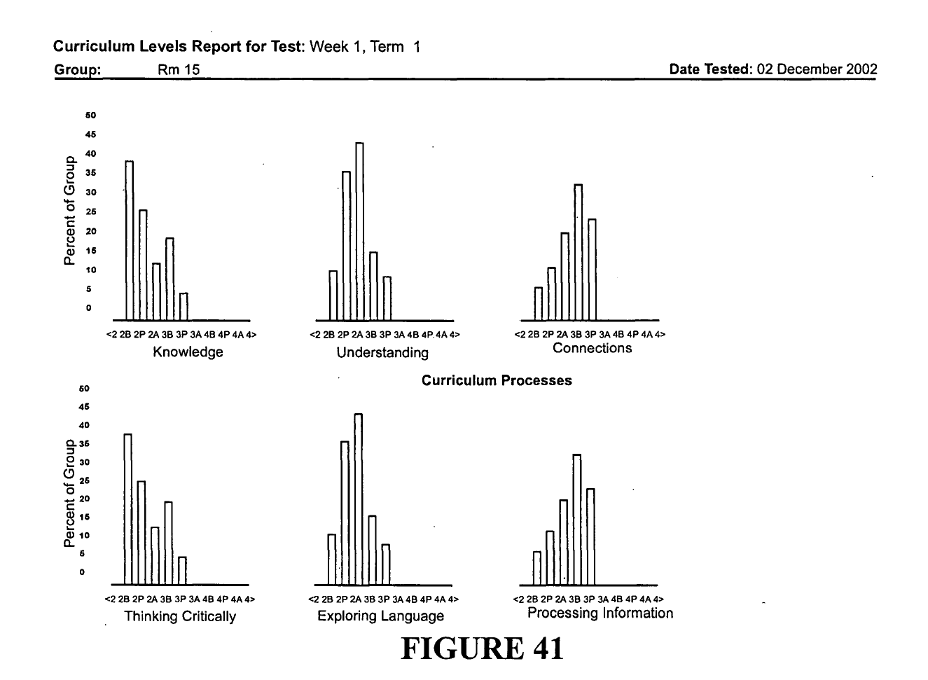

FIG. 41 illustrates a further report type that may be generated by the invention. This report type illustrates in the form of one or more graphs the curriculum level to which students are performing in each of the curriculum functions tested. If the user clicks on or otherwise selects a particular bar in one of the bar graphs they will be provided with the names of the students who are located at that level for that curriculum function. This type of report may be generated by selecting the curriculum levels tab 3740 from the example report generation interface in FIG. 37.

Many other different types of report output are possible based on the test result data, the student profile data and the comparative report data including tables, graphs and any combination of these. FIGS. 38 to 40 illustrate various variations on the reporting functionality of the invention.

Reports of the results of students taking the tests generated by the invention may be used by a teacher, teaching syndicate, and/or school Principal to identify any student learning needs and plan and implement teaching and learning opportunities for individual students or whole class groups. Any such plans may be explained to, or discussed with students, other teachers, parents/guardians, or appropriate third parties with reference to the reports.

Reports generated by the invention that focus on individual progress and achievement may be used by students for self-evaluation and goal setting. Individual focussed reports may also be used by teachers to inform parents and graphically demonstrate what students can and cannot yet do. Such reports may also illustrate any progress made by a student or group of students over time in any particular area(s) of a curriculum.

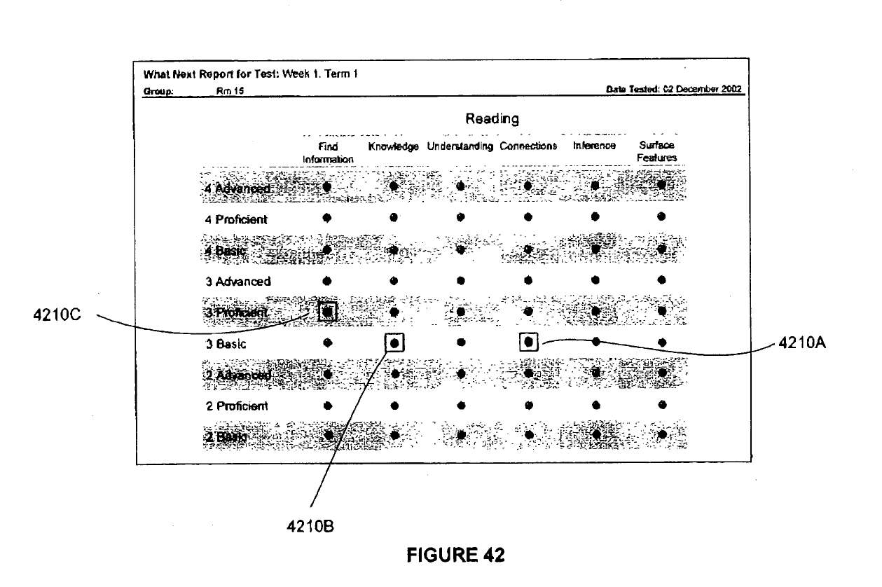

The What Next Profile tab 4160 in FIG. 41 may generate a very simple type of report or profile indicating the mean level at which students in a group are operating for each of the curriculum functions tested. An example of such a profile is shown in FIG. 42. As can be seen from this profile the students of Room 13 are performing at level 3 Proficient for the Find Information curriculum function, level 3 basic for the Knowledge curriculum function and level 3 basic for the Connections curriculum function.

Clicking on any of the circles or buttons in the profile may take the user to a web site or other external source 184 that provides teaching resources for a particular curriculum function at a particular level. While the level indicators 4210 are a guide as to the level at which students in the class are operating for that curriculum function, a user may wish to click on buttons one or more levels higher in order to source more challenging materials for their students.

The foregoing describes the invention including preferred forms thereof. Alterations and modifications as will be obvious to those skilled in the art are intended to be incorporated within the scope hereof, as defined by the accompanying claims.

1. A method of student assessment comprising the steps of:
analysing a curriculum into one or more curriculum functions; for one or more students storing a student profile in computer memory; storing in computer memory one or more test items for the curriculum comprising a test question and at least one curriculum function indicator, wherein each test question is calibrated to assess performance in at least one curriculum function of the curriculum and the curriculum function indicator represents the at least one curriculum functions assessed by the test question;
obtaining from a user a test specification comprising one or more curriculum function indicators;
generating a test comprising one or more question items selected and retrieved from data memory in accordance with the test specification;
administering the test to one or more candidate students;
for each student that took the test determining one or more scores for each question item in the test;
storing each score in the relevant student profile together with a reference to the corresponding question item; and
generating a report for one or more of the candidate students indicating performance levels for one or more of the curriculum functions tested.

2. A method as claimed in claim 1 wherein the report is based on comparison of the performance of the one or more candidate students in the one or more curriculum functions with the performance of a representative sample group of students in the same curriculum functions.

3. A method as claimed in claim 1 wherein a student profile comprises one or more demographic attributes of the student.

4. A method as claimed in claim 3 wherein the representative sample group is categorised according to the same one or more demographic attributes included in a student profile.

5. A method as claimed in claim 4 wherein the report is based on comparison of one or more candidate students in the one or more curriculum functions with the performance of a representative sample group of students in the same curriculum functions the students in the representative sample group having similar or identical demographic attributes as the one or more candidate students.

6. A method as claimed in claim 5 wherein a demographic attribute is gender.

7. A method as claimed in claim 5 wherein a demographic attribute is ethnicity.

8. A method as claimed in claim 5 wherein a demographic attribute is language background.

9. A method as claimed in claim 5 wherein a demographic attribute is school grade.

10. A method as claimed in claim 5 wherein a demographic attribute is geographic location.

11. A method as claimed in claim 5 wherein a demographic attribute is school type, school type comprising one or more school attributes.

12. A method as claimed in claim 11 wherein a school attribute is school size.

13. A method as claimed in claim 11 wherein a school attribute is percentage of minority students.

14. A method as claimed in claim 11 wherein a school attribute is decile rating.

15. A method as claimed in claim 11 wherein a school attribute may be public versus private.

16. A method as claimed in claim 11 wherein a school attribute may be rural versus urban.

17. A method as claimed in claim 1 wherein the test specification further comprises a proportional weighting for each curriculum function.

18. A method as claimed in claim 17 wherein the test items selected for inclusion in the test are selected proportionately according to the proportional weighting assigned to each curriculum function in the test specification.

19. A method as claimed in claim 1 wherein test items are further calibrated to one or more targeted curriculum levels.

20. A method as claimed in claim 20 wherein the report represents the curriculum level at which the one or more candidate students is performing in each curriculum function.

21. A student assessment system comprising:
a student profile for one or more students;
a test item bank comprising a plurality of test items, each test item comprising a test question and at least one curriculum function indicator wherein the question item is calibrated to the at least one curriculum function indicated by the at least one curriculum function indicator, a test generator configured to:
a) receive test specification data comprising one or more curriculum function indicators.
b) select and retrieve one or more test items from computer memory according to the test specification; and
c) assemble the selected test item(s) into a test, and a report generator configured to:
a) receive result data comprising a score for each student that took the test generated by the test generator for each test item in the test and store the result data in a corresponding student profile; and
b) generate a report for one or more of the students that took the test generated by the test generator indicating performance levels for one or more of the curriculum functions tested by the test items.

22. A system as claimed in claim 21 wherein the report generated by the report generator is based on the comparison of the performance of the one or more candidate students in the one or more curriculum functions with the performance of a representative sample group of students in the same curriculum functions.

23. A system as claimed in claim 21 wherein a student profile comprises one or more demographic attributes of the student.

24. A system as claimed in claim 23 wherein the representative sample group is categorised according to the same one or more demographic attributes included in a student profile.

25. A system as claimed in claim 24 wherein the report generated by the report generator is based on comparison of one or more of the students that took the test in the one or more curriculum function with the performance of a representative sample group of students in the same curriculum functions, the students in the representative sample group having similar or identical demographic attributes as the one or more students that took the test.

26. A system as claimed in claim 25 wherein a demographic attribute is gender.

27. A system as claimed in claim 25 wherein a demographic attribute is ethnicity.

28. A system as claimed in claim 25 wherein a demographic attribute is language background.

29. A system as claimed in claim 25 wherein a demographic attribute is school grade.

30. A system as claimed in claim 25 wherein a demographic attribute is geographic location.

31. A system as claimed in claim 25 wherein a demographic attribute is school type, school type comprising one or more school attributes.

32. A system as claimed in claim 31 wherein a school attribute is school size.

33. A system as claimed in claim 31 wherein a school attribute is percentage of minority students.

34. A system as claimed in claim 31 wherein a school attribute is decile rating.

35. A system as claimed in claim 31 wherein a school attribute may be public versus private.

36. A system as claimed in claim 11 wherein a school attribute may be rural versus urban.

37. A system as claimed in claim 21 wherein the test specification further comprises a proportional weighting for each curriculum function.

38. A system as claimed in claim 37 wherein the test items selected for inclusion in the test are selected proportionately according to the proportional weighting assigned to each curriculum function in the test specification.

39. A system as claimed in claim 21 wherein test items are further calibrated to one or more targeted curriculum levels.

40. A system as claimed in claim 30 wherein the report represents the curriculum level at which the one or more candidate students is performing in each curriculum function.

41. A student assessment computer program comprising;
a student profile maintained in computer memory for one or more students,
one or more test items for the curriculum maintained in a computer memory comprising a test question and at least one curriculum function indicator, wherein each test question is calibrated to assess performance in at least one curriculum function of the curriculum and the curriculum function indicator represents the at least one curriculum functions assessed by the test question;
a test generator configured to:
a) receive test specification data comprising one or more curriculum function indicators;
b) select and retrieve one or more test items from computer memory according to the test specification; and
c) assemble the selected test item(s) into a test, and
a report generator configured to
a) receive result data comprising a score for each student that took the test generated by the test generator for each test item in the test and store the result data in a corresponding student profile; and
b) generate a report for one or more of the students that took the test generated by the test generator indicating performance levels for one or more of the curriculum functions tested by the test items.

42. A computer program as claimed in claim 41 wherein the report is based on comparison of the performance of the one or more candidate students in the one or more curriculum functions with the performance of a representative sample group of students in the same curriculum functions.

43. A computer program as claimed in claim 41 wherein a student profile comprises one or more demographic attributes of the student.

44. A computer program as claimed in claim 43 wherein the representative sample group is categorised according to the same one or more demographic attributes included in a student profile.

45. A computer program as claimed in claim 44 wherein the report is based on comparison of one or more candidate students in the one or more curriculum functions with the performance of a representative sample group of students in the same curriculum functions the students in the representative sample group having similar or identical demographic attributes as the one or more candidate students.

46. A computer program as claimed in claim 45 wherein a demographic attribute is gender.

47. A computer program as claimed in claim 45 wherein a demographic attribute is ethnicity.

48. A computer program as claimed in claim 45 wherein a demographic attribute is language background.

49. A computer program as claimed in claim 45 wherein a demographic attribute is school grade.

50. A computer program as claimed in claim 45 wherein a demographic attribute is geographic location.

51. A computer program as claimed in claim 45 wherein a demographic attribute is school type, school type comprising one or more school attributes.

52. A computer program as claimed in claim 51 wherein a school attribute is school size.

53. A computer program as claimed in claim 51 wherein a school attribute is percentage of minority students.

54. A computer program as claimed in claim 51 wherein a school attribute is decile rating.

55. A computer program as claimed in claim 51 wherein a school attribute may be public versus private.

56. A computer program as claimed in claim 51 wherein a school attribute may be rural versus urban.

57. A computer program as claimed in claim 41 wherein the test specification further comprises a proportional weighting for each curriculum function.

58. A computer program as claimed in claim 57 wherein the test items selected for inclusion in the test are selected proportionately according to the proportional weighting assigned to each curriculum function in the test specification.

59. A method as claimed in claim 41 wherein test items arc further calibrated to one or more targeted curriculum levels.

60. A computer program as claimed in claim 59 wherein the report represents the curriculum level at which the one or more candidate students is performing in each curriculum function.
